(19) United States
(12) Patent Application Publication
(10) Pub. No.: US 2019/0287470 A1
(43) Pub. Date: Sep. 19, 2019

(54) FIELD SEQUENTIAL IMAGE DISPLAY DEVICE AND IMAGE DISPLAY METHOD

(71) Applicant: SHARP KABUSHIKI KAISHA, Sakai City, Osaka (JP)

(72) Inventor: MASAMITSU KOBAYASHI, Sakai City (JP)

(73) Assignee: SHARP KABUSHIKI KAISHA, Sakai City, Osaka (JP)

(21) Appl. No.: 16/334,919

(22) PCT Filed: Sep. 25, 2017
(86) PCT No.: PCT/JP2017/034498

§ 371 Date: Mar. 20, 2019

(30) Foreign Application Priority Data
Sep. 30, 2016 (JP) 2016-192943

(51) Int. Cl. G09G 3/36; G09G 3/34

(52) U.S. Cl. CPC G09G 3/3607; G09G 3/3406; G09G 2310/0235; G09G 2310/066; G09G 2320/0666

(57) ABSTRACT

Image display having high color reproducibility is performed with preventing an occurrence of color breakup while a decrease of light utilization efficiency is prevented. In a field sequential liquid crystal display apparatus in which a frame is configured with a red subframe, a green subframe, a blue subframe, and a white (common color) subframe, an image data conversion unit 30 converts input image data D1 corresponding to a red color, a green color, and a blue color into driving image data D2 corresponding to a plurality of subframes, for each pixel. That is, the driving image data D2 is generated from the input image data D1 by conversion processing with a distribution ratio and an adjustment coefficient represented by functions having values which smoothly change in accordance with a saturation, such that a pixel data value Wd of a white subframe in an achromatic pixel is greater than pixel data values Rd, Gd, and Bd of other subframes, and the pixel data value Wd of the white subframe in a pixel having a saturation S greater than a predetermined value is greater than the minimum value of the pixel data values Rd, Gd, and Bd of other subframes and is smaller than the maximum value thereof.

### TECHNICAL FIELD

The present invention relates to an image display device, and particularly, to a field sequential image display device and a field sequential liquid image display method.

### BACKGROUND ART

In the related art, a field sequential image display device that displays a plurality of subframes in one frame period is known. For example, a typical field sequential image display device includes a backlight including a red light source, a green light source, and a blue light source, and displays red, green, and blue subframes in one frame period. When a red subframe is displayed, a display panel is driven based on red image data, and the red light source emits light. A green subframe and a blue subframe are displayed in the similar manner. Three subframes displayed in a time division manner are combined on the retinae of an observer by an afterimage phenomenon, and thus the observer recognizes these subframes as one color image.

In the field sequential image display device, when the eyeline of the observer moves in a display screen, a situation in which the observer looks as if the colors of the subframes are separated from each other may occur (this phenomenon is referred to as “color breakup”). In order to suppress the occurrence of color breakup, an image display device that displays a white subframe in addition to the red, green, and blue subframes is known. An image display device that performs amplification processing of multiplying input image data by one or more coefficients when driving image data including red image data, green image data, blue image data, and white image data is obtained based on the input image data including red image data, green image data, and blue image data is known.

Relating to an image display device disclosed in this application, PTLs 1 and 2 disclose a method of obtaining driving image data including red image data, green image data, blue image data, and white image data based on input image data including red image data, green image data, and blue image data, in an image display device which includes subpixels of red, green, blue, and white colors and is not the field sequential type.

### CITATION LIST

### Patent Literature

PTL 1: Japanese Unexamined Patent Application Publication No. 2001-147666

PTL 2: Japanese Unexamined Patent Application Publication No. 2008-139809

PTL 3: Japanese Unexamined Patent Application Publication No. 2010-33009

PTL 4: Japanese Unexamined Patent Application Publication No. 2002-229531

### SUMMARY OF INVENTION

### Technical Problem

In the above-described field sequential image display device, a white subframe is provided as a common color subframe for preventing the occurrence of color breakup, and driving image data is generated by image-data conversion processing including amplification processing of multiplying input image data by one or more coefficients, a difference in hue, saturation, and luminance may occur between a color (referred to as “an extended input color” below) indicated by image data subjected to the amplification processing and a color (referred to as “an actual display color” below) which is actually displayed in a display device such as a liquid crystal panel. In this case, image display having sufficiently high color reproducibility is not performed.

In the above-described field sequential image display device, if light utilization efficiency in the image display device when the white is displayed in maximum is set to be the highest in order to need reduction of consumed power, a distribution ratio to a white subframe as the common color subframe in conversion from input image data to driving image data is limited. As described above, if the distribution ratio to the white subframe in white display in which color breakup occurs most frequently is limited, tolerance of the occurrence of color breakup may not be possible.

Thus, it is desired to provide a field sequential image display device and a field sequential image display method in which image display having high color reproducibility is performed, and the occurrence of color breakup is prevented while preventing the decrease of the light utilization efficiency.

### Solution to Problem

According to a first aspect of the present invention, there is provided a field sequential image display device in which a plurality of subframe periods including a plurality of primary-color subframe periods respectively corresponding to a plurality of primary colors and at least one common-color subframe period is included in each frame period. The field sequential image display device includes an image data conversion unit that receives input image data corresponding to the plurality of primary colors and generates driving image data corresponding to the plurality of subframe periods from the input image data by obtaining a pixel data value of each of the plurality of subframe periods for each pixel of an input image represented by the input image data, based on the input image data, and a display unit that displays an image based on the driving image data.

The image data conversion unit performs conversion processing of generating the driving image data from the input image data such that a pixel data value of the achromatic pixel in the common-color subframe period is set to be greater than any of pixel data values in the plurality of primary-color subframe periods in a case where a hue and a saturation of each pixel of the input image in an HSV space are maintained, and the input image includes an achromatic pixel, and that a pixel data value of the pixel in the common-color subframe period is set to be greater than a minimum value and smaller than a maximum value of the pixel data values in the plurality of primary-color subframe periods in a case where the input image includes the pixel having the saturation greater than a predetermined value.

According to a second aspect of the present invention, in the first aspect of the present invention, the image data conversion unit determines a distribution ratio in accordance with the saturation of the pixel, for each pixel in the input image, the distribution ratio defined as a ratio of the pixel data value in the common-color subframe period in the driving image data to the maximum value allowed to be taken by the pixel data value in the common-color subframe period, determines an adjustment coefficient to be multiplied by a value of the pixel, based on the pixel data values in the plurality of subframe periods in a range in which the pixel is allowed to be displayed in the display unit, in accordance with the saturation of the pixel, for each pixel in the input image, and generates the driving image data by obtaining the pixel data value of each of the plurality of subframe periods from the value of the pixel based on the adjustment coefficient and the distribution ratio, for each pixel in the input image.

According to a third aspect of the present invention, in the first aspect of the present invention, the image data conversion unit determines a distribution ratio in accordance with the saturation of the pixel, for each pixel in the input image, the distribution ratio defined as a ratio of a display light quantity of a common color component, which is to be emitted in the common-color subframe period to a display light quantity of the common color component, which is to be emitted in one frame period for displaying the pixel, determines an adjustment coefficient to be multiplied by a value of the pixel, based on the pixel data values in the plurality of subframe periods in a range in which the pixel is allowed to be displayed in the display unit, in accordance with the saturation of the pixel, for each pixel in the input image, and generates the driving image data by obtaining the pixel data value of each of the plurality of subframe periods from the value of the pixel based on the adjustment coefficient and the distribution ratio, for each pixel in the input image.

According to a fourth aspect of the present invention, in the second or third aspect of the present invention, the image data conversion unit determines the adjustment coefficient such that a maximum value is linearly limited with respect to a minimum value among the pixel data values in the plurality of subframe periods, for each pixel in the input image.

According to a fifth aspect of the present invention, in the second, third, or fourth aspect of the present invention, the image data conversion unit assumes a function of the saturation, which indicates a tentative coefficient for obtaining the adjustment coefficient and a function of the saturation, which indicates a correction coefficient to be multiplied by the tentative coefficient, and obtains a multiplication result of the tentative coefficient and the correction coefficient based on the saturation of the pixel for each pixel in the input image, as the adjustment coefficient.

According to a sixth aspect of the present invention, in the fifth aspect of the present invention, the tentative coefficient is set to indicate a maximum value allowed to be taken by the adjustment coefficient in a case where the distribution ratio is set such that the pixel data value of the pixel in the input image in the common-color subframe period is greater than a minimum value of the pixel data values in the plurality of primary-color subframe periods and is smaller than a maximum value thereof, and the correction coefficient is set such that the multiplication result of the tentative coefficient and the correction coefficient is equal to the maximum value allowed to be taken by the adjustment coefficient in a case where the distribution ratio is set to cause the pixel data value of the pixel in the common-color subframe period to be greater than any pixel data value in the plurality of primary-color subframe periods, when the pixel in the input image is achromatic.

According to a seventh aspect of the present invention, in the second, third, or fourth aspect of the present invention, the image data conversion unit assumes a function of the saturation, which indicates a tentative coefficient for obtaining the adjustment coefficient, and obtains a value corresponding to a proportional division point of a difference between the tentative coefficient based on the saturation of the pixel and a predetermined value, as the adjustment coefficient, for each pixel in the input image.

According to an eighth aspect of the present invention, in the seventh aspect of the present invention, the tentative coefficient is set to indicate a maximum value allowed to be taken by the adjustment coefficient in a case where the distribution ratio is set such that the pixel data value of the pixel in the input image in the common-color subframe period is smaller than a maximum value of the pixel data values in the plurality of primary-color subframe periods and is greater than a minimum value thereof, and the image data conversion unit obtains the adjustment coefficient in a manner that the image data conversion unit proportionally divides a difference between the tentative coefficient and the predetermined value such that the proportional division point corresponds to a maximum value allowed to be taken by the adjustment coefficient when the pixel in the input image is achromatic in a case where the distribution ratio is set to cause the pixel data value of the pixel in the input image in the common-color subframe period to be greater than any pixel data value in the plurality of primary-color subframe periods.

According to a ninth aspect of the present invention, in any one of the second to eighth aspects of the present invention, the image data conversion unit includes a first function which includes at least one first parameter and is the function of the saturation, which indicates the distribution ratio and a second function which includes at least one second parameter and is the function of the saturation, which indicates the adjustment coefficient, and is capable of adjusting the distribution ratio and the adjustment coefficient with the at least one first parameter and the at least one second parameter.

According to a tenth aspect of the present invention, in the ninth aspect of the present invention, the display unit includes a light source unit that emits light having a corresponding color in each subframe period, a light modulation unit that causes the light from the light source unit to be transmitted therethrough or be reflected thereby, a light-source-unit driving circuit that drives the light source unit to irradiate the light modulation unit with the light having the corresponding color in each subframe period, and a light-modulation-unit driving circuit that controls transmittance or reflectance in the light modulation unit such that an image of the corresponding color in each subframe period is displayed. The at least one first parameter and the at least one second parameter include a light emission control parameter, and the light-source-unit driving circuit controls emission luminance of the common color in the light source unit based on the light emission control parameter.

According to an eleventh aspect of the present invention, in the tenth aspect of the present invention, the image data conversion unit determines the distribution ratio of an achromatic pixel in the input image to be greater than WBR/(1+WSR) when the control parameter is set as WBR, and the light-source-unit driving circuit drives the light source unit such that the light source unit in the common-color subframe period emits light with luminance obtained by multiplying emission luminance of the light source unit in each primary-color subframe period by the light emission control parameter WBR.

According to a twelfth aspect of the present invention, in the eleventh aspect of the present invention, the image data conversion unit obtains the distribution ratio and the coefficient in accordance with functions having a value which smoothly changes depending on the saturation.

According to a thirteenth aspect of the present invention, in the first aspect of the present invention, the image data conversion unit includes a parameter storage unit that stores a parameter used in the conversion processing, and the parameter storage unit stores a parameter in accordance with response characteristics in image display in the display unit.

According to a fourteenth aspect of the present invention, in the thirteenth aspect of the present invention, the image data conversion unit further stores a parameter for designating a range of the maximum value in accordance with the minimum value of the pixel data values of each pixel in the input image in the plurality of subframe periods.

According to a fifteenth aspect of the present invention, in the first aspect of the present invention, the image data conversion unit includes a parameter storage unit that stores a parameter used in the conversion processing, and the display unit includes a temperature sensor, the parameter storage unit stores a plurality of values for the parameter, in accordance with a temperature, and the image data conversion unit selects the value in accordance with the temperature measured by the temperature sensor among the plurality of values stored in the parameter storage unit and uses the selected value in the conversion processing.

According to a sixteenth aspect of the present invention, in the first aspect of the present invention, the image data conversion unit includes a frame memory that stores the input image data, and generates the driving image data corresponding to a pixel, based on the input image data which has been stored in the frame memory and corresponds to a plurality of pixels, for each pixel in the input image.

According to a seventeenth aspect of the present invention, in the first aspect of the present invention, the image data conversion unit performs the conversion processing on normalized luminance data.

According to an eighteenth aspect of the present invention, in the seventeenth aspect of the present invention, the image data conversion unit obtains the driving image data by performing response compensation processing on image data obtained after the conversion processing.

According to a nineteenth aspect of the present invention, in the first aspect of the present invention, the plurality of primary colors includes blue, green, and red, and the common color is white.

According to a twentieth aspect of the present invention, there is provided a field sequential image display method in which a plurality of subframe periods including a plurality of primary-color subframe periods respectively corresponding to a plurality of primary colors and at least one common-color subframe period is included in each frame period. The method includes an image-data conversion step of receiving input image data corresponding to the plurality of primary colors and generating driving image data corresponding to the plurality of subframe periods from the input image data by obtaining a pixel data value of each of the plurality of subframe periods for each pixel of an input image represented by the input image data, based on the input image data, and a display step of displaying an image based on the driving image data.

In the image-data conversion step, conversion processing of generating the driving image data from the input image data is performed such that a pixel data value of the achromatic pixel in the common-color subframe period is set to be greater than any of pixel data values in the plurality of primary-color subframe periods in a case where a hue and a saturation of each pixel of the input image in an HSV space are maintained, and the input image includes an achromatic pixel, and that a pixel data value of the pixel in the common-color subframe period is set to be greater than a minimum value and smaller than a maximum value of the pixel data values in the plurality of primary-color subframe periods in a case where the input image includes the pixel having the saturation greater than a predetermined value.

Other aspects of the present invention are clear from descriptions regarding the first to twentieth aspects of the present invention and embodiments described later, and thus descriptions thereof will be omitted.

### Advantageous Effects of Invention

According to the first aspect of the present invention, the driving image data is generated such that the hue and the saturation in the HSV space for each pixel of an input image represented by input image data is maintained. Thus, it is possible to perform image display having high color reproduction in the display unit. Since the driving image data is generated such that a pixel data value of an achromatic pixel in the common-color subframe period is greater than any pixel data value in the plurality of primary-color subframe periods in a case where the input image includes the achromatic pixel, it is possible to suppress the occurrence of color breakup even in achromatic image display in which the color breakup occurs frequently. Further, the driving image data is generated such that a pixel data value of a pixel in the common-color subframe period is greater than the minimum value of pixel data values in the plurality of primary-color subframe periods and is smaller than the maximum value thereof in a case where the input image includes the pixel having a saturation greater than the predetermined value. Thus, image display having high color reproducibility is performed, and the decrease of light utilization efficiency is also suppressed in comparison to a configuration in the related art, in which the distribution ratio of the common color subframe is set to the maximum value of 1.0. In this manner, according to the first aspect of the present invention, it is possible to prevent the occurrence of color breakup with preventing the decrease of light utilization efficiency and to perform image display having high color reproducibility, in a fieid sequential image display device.

According to the second or third aspect of the present invention, for each pixel in the input image, the distribution ratio in the common color subframe is determined in accordance with the saturation of the pixel, and the adjustment coefficient to be multiplied by the value of the pixel is determined based on the pixel data value in each subframe period, in the range in which the pixel is allowed to be displayed in the display unit, in accordance with the saturation of the pixel. Since the driving image data is generated based on the distribution ratio and the adjustment coefficient described above, it is possible to prevent the occurrence of color breakup with preventing the decrease of light utilization efficiency and to perform image display having high color reproducibility, in a field sequential image display device.

According to the fourth aspect of the present invention, the maximum value of the driving image data in one frame period is linearly limited with respect to the minimum value of the driving image data in the one frame period. Thus, the range of the maximum value is determined in accordance with the minimum value. Thus, it is possible to suppress a change of the image data after the conversion, in one frame period, and to improve color reproducibility of the image display device.

According to the fifth aspect of the present invention, the driving image data is generated by the conversion processing in which the multiplication result of the tentative coefficient by the function of the saturation and the correction coefficient by the function of the saturation is set as the adjustment coefficient. Thus, effects similar to those in the second or fourth aspect of the present invention are obtained.

According to the sixth aspect of the present invention, the tentative coefficient is set to indicate the maximum value allowed to be taken by the adjustment coefficient in a case where the distribution ratio is set to cause a pixel data value of a pixel in the input image in the common-color subframe period is greater than the minimum value of the pixel data values in the plurality of primary-color subframe periods and is smaller than the maximum value thereof. The correction coefficient is set to cause the multiplication result of the tentative coefficient and the correction coefficient to be equal to the maximum value allowed to be taken by the adjustment coefficient in a case where the distribution ratio is set to cause the pixel data value of a pixel in the common-color subframe period to be greater than any pixel data value in the plurality of primary-color subframe periods, when the pixel in the input image is achromatic. Since the driving image data is generated by the conversion processing in which the multiplication result of the tentative coefficient and the correction coefficient described above is set as the adjustment coefficient, effects similar to those in the fifth aspect of the present invention are obtained.

According to the seventh aspect of the present invention, the driving image data is generated by the conversion processing in which the value corresponding to the proportional division point of the difference between the tentative coefficient by the function of the saturation and the predetermined value is set as the adjustment coefficient. Thus, effects similar to those in the second or fourth aspect of the present invention are obtained.

According to the eighth aspect of the present invention, the tentative coefficient is set to indicate the maximum value allowed to be taken by the adjustment coefficient in a case where the distribution ratio is set to cause the pixel data value of a pixel in the input image in the common-color subframe period to be smaller than the maximum value of the pixel data values in the plurality of primary-color subframe periods and to be greater than the minimum value thereof. The difference between the tentative coefficient and the predetermined value is proportionally divided such that the proportional division point corresponds to the maximum value allowed to be taken by the adjustment coefficient when a pixel in the input image is achromatic in a case where the distribution ratio is set to cause the pixel data value of the pixel in the input image in the common-color subframe period to be greater than any pixel data value in the plurality of primary-color subframe periods. Since the driving image data is generated by the conversion processing in which the value corresponding to the proportional division point is set as the adjustment coefficient, effects similar to those in the seventh aspect of the present invention are obtained.

According to the ninth aspect of the present invention, the distribution ratio may be adjusted by at least one first parameter in the first function. The adjustment coefficient may be adjusted by at least one second parameter in the second function. Therefore, it is possible to more reliably obtain the effects in the second to eighth aspects of the present invention by adjusting the distribution ratio and the adjustment coefficient in accordance with the specification and use of the image display device.

According to the tenth aspect of the present invention, it is possible to reduce heat generated in the light source by controlling the luminance of the light source when a common color subframe is displayed in a field sequential image display device that includes the display unit using the light modulation unit that cause light from the light source to be transmitted therethrough or be reflected thereby.

According to the eleventh aspect of the present invention, in the field sequential image display device that includes the display unit using the light modulation unit that causes light from the light source to be transmitted therethrough or be reflected thereby, the distribution ratio of an achromatic pixel in the input image when the control parameter is set as WBR is determined to be greater than WBR/1+WBR). The light source unit emits light with luminance obtained by multiplying emission luminance of the light source unit in each primary-color subframe period by the light emission control parameter WBR, in the common-color subframe period. Thus, it is possible to prevent the occurrence of color breakup even in achromatic image display in which the color breakup occurs frequently.

According to the twelfth aspect of the present invention, the distribution ratio and the adjustment coefficient are obtained in accordance with the functions which smoothly change depending on the saturation. Thus, it is possible to prevent the occurrence of distortion of an image when a gradation image is displayed. Thus, it is possible to perform image display having high color reproducibility.

According to the thirteenth aspect of the present invention, it is possible to improve color reproducibility by setting the suitable parameter in accordance with the response characteristics of the display unit.

According to the fourteenth aspect of the present invention, the maximum value of driving image data in one frame period is limited in accordance with the minimum value of the driving image data in one frame period, by using the parameter stored in the parameter storage unit. Thus, it is possible to improve color reproducibility.

According to the fifteenth aspect of the present invention, the conversion processing is performed based on the parameter in accordance with the temperature of the display unit. Thus, it is possible to improve color reproducibility even in a case where the response characteristics of the display unit change in accordance with the temperature.

According to the sixteenth aspect of the present invention, the conversion processing is performed based on the input image data corresponding to the plurality of pixels. Thus, it is possible to prevent the occurrence of a situation in which the color of a pixel rapidly changes in the spatial direction or the time direction.

According to the seventeenth aspect of the present invention, the conversion processing is performed on normalized luminance data. Thus, it is possible to accurately perform the conversion processing.

According to the eighteenth aspect of the present invention, the response compensation processing is performed on image data after the conversion processing has been performed. Thus, it is possible to display a desired image even in a case where the response rate of the display unit is slow.

According to the nineteenth aspect, in the image display device that displays subframes of three primary colors and the white color based on the input image data corresponding to the three primary colors, it is possible to improve color reproducibility.

Effects in other aspects of the present invention are clearly obtained from the effects in the first to nineteenth aspects of the present invention and the following descriptions of embodiments. Thus, descriptions thereof will not be repeated.

### BRIEF DESCRIPTION OF DRAWINGS

FIG. 1 is a block diagram illustrating a configuration of an image display device according to a first embodiment.

FIG. 2 is a diagram illustrating a parameter in the image display device according to the first embodiment.

FIG. 3 is a flowchart illustrating image-data conversion processing in the image display device according to the first embodiment.

FIG. 4 is a diagram illustrating a range of a saturation and a distribution ratio of a white subframe in the image display device according to the first embodiment.

FIG. 5 is a diagram illustrating the distribution ratio WRs of the white subframe in the first embodiment.

FIG. 6 is a diagram illustrating a graph (parameter WRW=0.5) of the distribution ratio WRs in the first embodiment.

FIG. 7 is a diagram illustrating a graph (parameter WRW=0.6) of the distribution ratio WRs in the first embodiment.

FIG. 8 is a diagram illustrating a correction coefficient Kh in an adjustment coefficient Ks according to a first example of the first embodiment.

FIG. 9 is a diagram illustrating the adjustment coefficient Ks according to the first example of the first embodiment.

FIG. 10 is a diagram illustrating a graph (parameter WRW=0.5) of the adjustment coefficient Ks according to the first example of the first embodiment.

FIG. 11 is a diagram illustrating a graph (parameter WRW=0.6) of the adjustment coefficient Ks according to the first example of the first embodiment.

FIG. 12 is a diagram illustrating the adjustment coefficient Ks according to a second example of the first embodiment.

FIG. 13 is a diagram illustrating a graph (parameter WRW=0.5) of the adjustment coefficient Ks according to the second example of the first embodiment.

FIG. 14 is a diagram illustrating a graph (parameter WRW=0.6) of the adjustment coefficient Ks according to the second example of the first embodiment.

FIG. 15 is a diagram illustrating the correction coefficient Kh in the adjustment coefficient Ks according to a third example of the first embodiment.

FIG. 16 is a diagram illustrating the adjustment coefficient Ks according to the third example of the first embodiment.

FIG. 17 is a diagram illustrating a graph (parameter WRW=0.5) of the adjustment coefficient Ks according to the third example of the first embodiment.

FIG. 18 is a diagram illustrating a graph (parameter WRW=0.6) of the adjustment coefficient Ks according to the third example of the first embodiment.

FIG. 19 is a diagram illustrating the adjustment coefficient Ks according to a fourth example of the first embodiment.

FIG. 20 is a diagram illustrating a graph (parameter WRW=0.5) of the adjustment coefficient Ks according to the fourth example of the first embodiment.

FIG. 21 is a diagram illustrating a graph (parameter WRW=0.6) of the adjustment coefficient Ks according to the fourth example of the first embodiment.

FIGS. 22(A) to 22(C) are diagrams illustrating graphs of a coefficient Ksv in a case where low-luminance-portion noise handling processing is performed in the first embodiment.

FIG. 23 is a diagram illustrating a range allowed to be taken by the coefficient Ksv in a case where the low-luminance-portion noise handling processing is performed in the first embodiment.

FIG. 24 is a diagram illustrating a range allowed to be taken by a value NS in a case where the low-luminance-portion noise handling processing is performed in the first embodiment.

FIG. 25 is a diagram illustrating a graph of the value NS set in a case where the low-luminance-portion noise handling processing is performed in the first embodiment.

FIG. 26 is a diagram illustrating graphs of the coefficients Ksv and Ks, which are used for describing effects of the low-luminance-portion noise handling processing in the first embodiment.

FIG. 27 is a diagram illustrating an example of image-data conversion processing in a case where the low-luminance-portion noise handling processing is not performed in the first embodiment.

FIG. 28 is a diagram illustrating an example of the image-data conversion processing in a case where the low-luminance-portion noise handling processing is performed in the first embodiment.

FIG. 29 is a diagram illustrating the distribution ratio in a case where light utilization efficiency of a liquid crystal panel is set to be maximum.

FIG. 30 is a diagram illustrating the distribution ratio by the image-data conversion processing in the first embodiment.

FIG. 31 is a block diagram illustrating a configuration of an image display device according to a second embodiment.

FIG. 32 is a block diagram illustrating a configuration of an image display device according to a third embodiment.

FIG. 33 is a block diagram illustrating a configuration of an image display device according to a modification example of the first embodiment.

### DESCRIPTION OF EMBODIMENTS

Hereinafter, image display devices and image display methods according to embodiments will be described with reference to the drawings. Firstly, the following is noted. “Computation” provided in the following descriptions includes the meaning that “a computation result is stored in a table in advance, and the computation result is obtained based on the table”, in addition to the meaning of “obtaining a computation result with a computing machine”.

### 1. First Embodiment

<1.1 Overall Configuration>

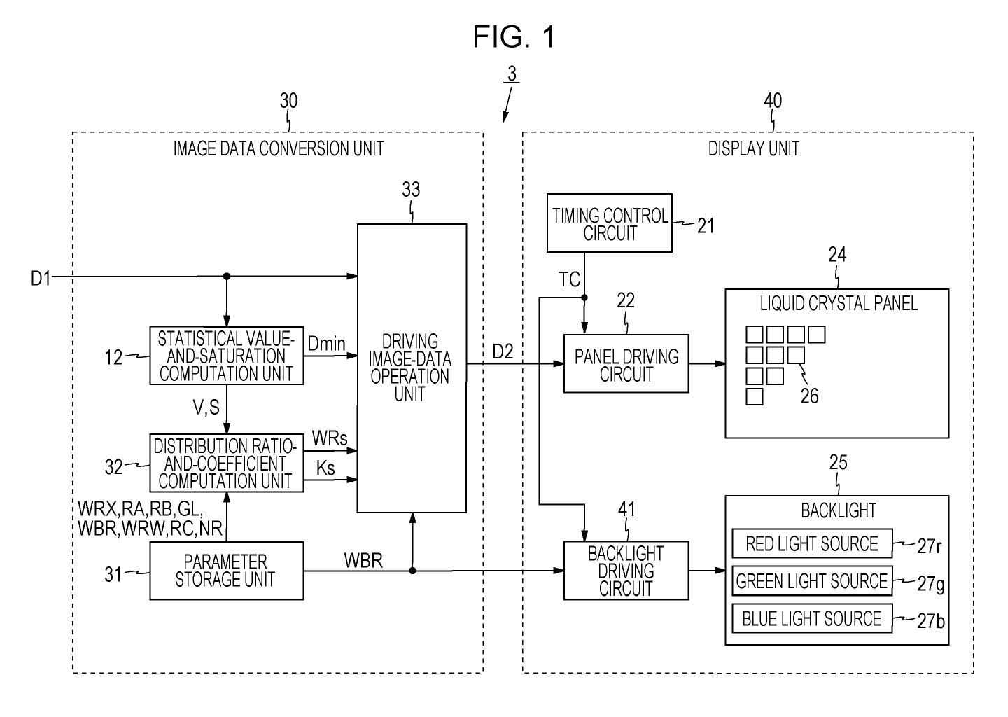

FIG. 1 is a block diagram illustrating a configuration of an image display device according to a first embodiment. An image display device 3 illustrated in FIG. 1 includes an image data conversion unit 30 and a display unit 40. The image data conversion unit 30 includes a parameter storage unit 31, the statistical value-and-saturation computation unit 12, a distribution ratio-and-coefficient computation unit 32, and a driving image-data operation unit 33. The display unit 40 includes a timing control circuit 21, a panel driving circuit 22, a backlight driving circuit 41, a liquid crystal panel 24 as a light modulation unit, and a backlight 25 as a light source unit. The image display device 3 selectively performs gradation difference limit processing in addition to low-luminance-portion noise handling processing.

The image display device J is a field sequential liquid crystal display apparatus. The image display device 3 divides one frame period into a plurality of subframes periods and displays a different color subframe in each of the subframe periods. Hereinafter, it is assumed that the image display device 3 divides one frame period into four subframe periods and respectively displays white, blue, green, and red subframes in first to fourth subframe periods. In the image display device 3, a white subframe is a common color subframe. “The color” in each subframe indicates a light source color. It is assumed that the display unit 40 in the image display device 3 can display “a white color” as a desired color temperature in a case where “1” (maximum value) is assigned to any of a red color, a green color, and a blue color in light-source driving data used for driving the backlight 25.

Input image data D1 including red image data, green image data, and blue image data is input to the image display device 3. The image data conversion unit 30 obtains driving image data D2 corresponding to white, blue, green, and red subframes, based on the input image data D1. The processing is referred to as “image-data conversion processing” below. Pieces of the driving image data D2 corresponding to white, blue, green, and red subframes are referred to as “white image data, blue image data, green image data, and red image data which are included in the driving image data D2”, respectively. The display unit 40 displays the white, blue, green, and red subframes in one frame period, based on the driving image data D2.

The timing control circuit 21 outputs a timing control signal TC to the panel driving circuit 22 and the backlight driving circuit 41. The panel driving circuit 22 drives the liquid crystal panel 24 based on the timing control signal TC and the driving image data D2. The backlight driving circuit 41 drives the backlight 25 based on the timing control signal TC and a parameter WBR (which will be described later) from the parameter storage unit 31. The liquid crystal panel 24 includes a plurality of pixels 26 arranged in two dimensions. The backlight 25 includes a red light source 27r, a green light source 27g, and a blue light source 27b (the light sources 27r, 27g, and 27b are also collectively referred to as “a light source 27” below). The backlight 25 may include a white light source. For example, a light emitting diode (LED) is used as the light source 27.

In the first subframe period, the panel driving circuit 22 drives the liquid crystal panel 24 based on white image data included in the driving image data D2, and the backlight driving circuit 41 causes the red light source 27r, the green light source 27g, and the blue light source 27b to emit light. Thus, a white subframe is displayed. In a case where the backlight 25 includes a white light source, the backlight driving circuit 41 may cause the white light source to emit light in the first subframe period.

In the second subframe period, the panel driving circuit 22 drives the liquid crystal panel 24 based on blue image data included in the driving image data D2, and the backlight driving circuit 41 causes the blue light source 27b to emit light. Thus, a blue subframe is displayed. In the third subframe period, the panel driving circuit 22 drives the liquid crystal panel 24 based on green image data included in the driving image data D2, and the backlight driving circuit 41 causes the green light source 27g to emit light. Thus, a green subframe is displayed. In the fourth subframe period, the panel driving circuit 22 drives the liquid crystal panel 24 based on red image data included in the driving image data D2, and the backlight driving circuit 41 causes the red light source 27r to emit light. Thus, a red subframe is displayed.

<1.2 Details of Image Data Conversion Unit>

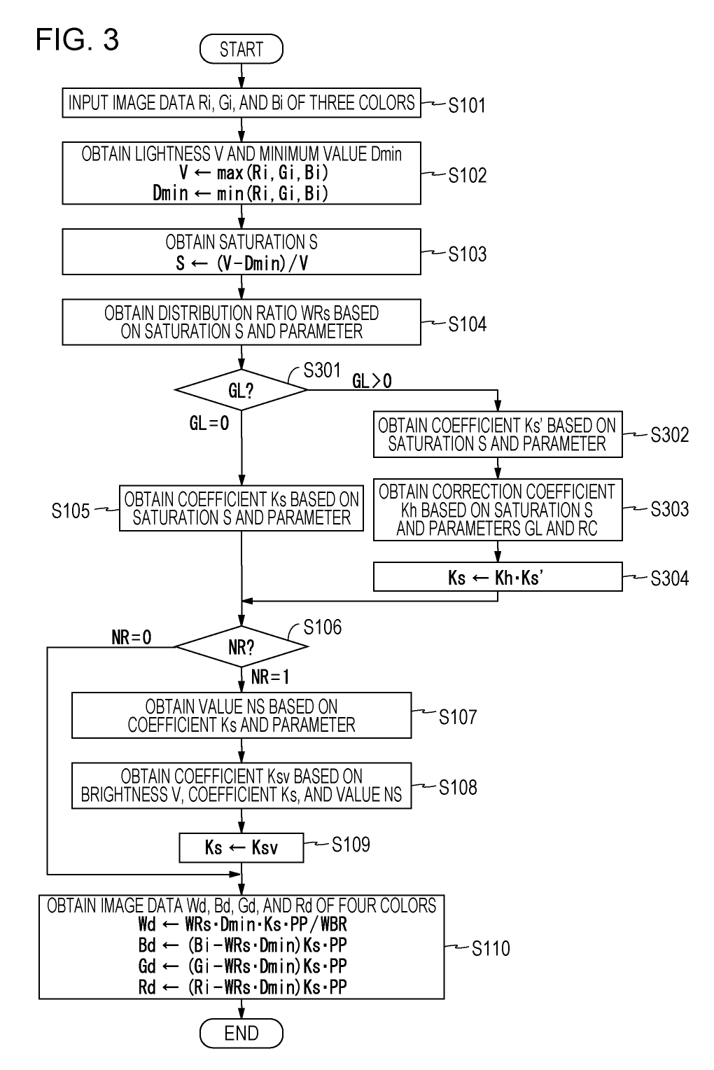

Details of the image data conversion unit 30 will be described below. Red image data, green image data, and blue image data which are included in the input image data D1 are luminance data normalized to have a value of 0 to 1. When pieces of image data of three colors are equal to each other, the pixel 26 becomes achromatic. Red image data, green image data, and blue image data which are included in the driving image data D2 are also luminance data normalized to have a value of 0 to 1. For example, a microcomputer including a central processing unit (CPU) and a memory may be used as the image data conversion unit 30. The image data conversion unit 30 may be realized in software by the microcomputer executing a predetermined program corresponding to FIG. 3 described later. Instead, the entirety of the image data conversion unit 30 may be realized with dedicated hardware (typically, application specific integrated circuit designed to be dedicated).

In image-data conversion processing, amplification and compression processing and color-component conversion processing are performed (see Expressions (3a) to (3d) described later). The amplification and compression processing is performed with an adjustment coefficient Ks which is a coefficient to be multiplied by the values (referred to as “BGR pixel data values of an input image” below) of the blue color, the green color, and the red color in each pixel of an image (input image) representing input image data D1. In the color-component conversion processing, a distribution ratio WRs for a white subframe of a white color component in this pixel is obtained, and the BGR pixel data value of the input image subjected to the amplification and compression processing is converted into pixel data values (referred to as “WBGR pixel data values of an output image” below) of a white subframe, a blue subframe, a green subframe, and a red subframe, based on the distribution ratio WRs. In the image-data conversion processing, white image data (having a value to be distributed to a common color subframe) included in the driving image data D2 is determined in a range of 0 to 1. The distribution ratio WRs indicates a ratio of the value of the white image data to the maximum value allowed to be taken by the white image data (minimum value of image data having three colors) (the ratio is referred to as “a distribution ratio of a common color subframe” or “a distribution ratio of a white subframe” or simply referred to as “a distribution ratio” below). The ratio is obtained for each pixel. For example, in a case where the distribution ratio WRs is determined to be 0.6 when red image data included in input image data D1 is 0.5, and green image data and blue image data are 1, white image data included in driving image data D2 is 0.3. In the embodiment as described later, the luminance of the light source 27 when the white subframe is displayed is controlled to be WBR times the luminance of the light source 27 when other subframes are displayed, in accordance with the parameter WBR. Therefore, a relation between the pixel data value in a white subframe period and display luminance by this pixel data value depends on the parameter WBR. Considering this point, the distribution ratio WRs is to be defined as a ratio of a value obtained by a product of the white image data and the parameter WBR in the driving image data D2, to the minimum value of the BGR pixel data values of the input image subjected to the amplification and compression processing. More generally, the distribution ratio WRs is defined as a ratio of the display light quantity of a white color component to be emitted in the white subframe period, to the display light quantity of the white color component to be emitted in one frame period for displaying a pixel, for each pixel in the input image. In the embodiment, in a case where the parameter WBR is fixed to “1” (case where the parameter WBR is not applied), the distribution ratio WRs may be defined as a ratio of the white image data (obtained for each pixel) to the maximum value allowed to be taken by the white image data.

The parameter storage unit 31 stores parameters WRX, RA, RB, WBR, WRW, GL, RC, and NR used in image-data conversion processing. The statistical value-and-saturation computation unit 12 obtains the maximum value D max, the minimum value D min, and the saturation S based on input image data D1, for each pixel. The maximum value D max is equal to the brightness V in an HSV color space. Thus, in the following descriptions, the maximum value D max is described as the brightness V. The distribution ratio-and-coefficient computation unit 32 obtains the distribution ratio WRs and an adjustment coefficient (also simply referred to as “a coefficient” below) Ks based on the brightness V, the saturation S, and the parameters WRX, RA, RB, WBR, WRW, GL, RC, and NR (details will be described later). The driving image-data operation unit 33 obtains driving image data D2 based on the input image data D1, the minimum value D min, the distribution ratio WRs, the coefficient Ks, and the parameter WBR.

The parameters stored in the parameter storage unit 31 will be described below. The parameter WRX is a parameter depending on response characteristics of a pixel 26 provided in the display unit 20. The parameter WRX is included in a calculation expression of obtaining the distribution ratio WRs. The parameter WBR designates the luminance of the light source 27 which is used when a white subframe is displayed and is provided in the backlight 25, and takes a value in a range of 0≤WBR≤1. The parameter WRW is a parameter prepared to allow the distribution ratio WRs when the saturation S is 0 (at time of an achromatic color) to be set to a value greater than WBR/(1+WBR), in order to more reduce the occurrence of color breakup. The parameter WRW takes a value in the range of 0≤WRW≤1. The parameter GL indicates the type of gradation difference limit processing and takes a value of 0, 1, or 2. The value of 0 indicates that gradation difference limit processing is not performed. The value of 1 or 2 indicates that the gradation difference limit processing is performed. The parameter RC is provided in a calculation expression of obtaining the coefficient Ks when the gradation difference limit processing is performed. The parameter NR indicates whether or not low-luminance-portion noise handling processing is performed, and takes a value of 0 or 1. The value of 0 indicates that low-luminance-portion noise handling processing is not performed. The value of 1 indicates that the low-luminance-portion noise handling processing is performed. Details of the gradation difference limit processing and the low-luminance-portion noise handling processing will be described later.

The minimum value of driving image data D2 in one frame period is set as DD min, and the maximum value thereof is set as DD max. In a case where low-luminance-portion noise handling processing is not performed, the distribution ratio-and-coefficient computation unit 32 obtains the coefficient Ks in accordance with the parameters RA and RB stored in the parameter storage unit 31, so as to satisfy the following expression (1).

DD max≤RA·DD min+RB (1)

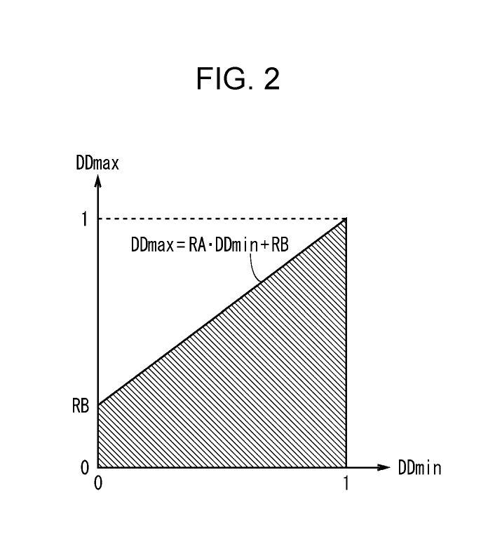

For example, in a case of RB=1−RA, the range satisfying the expression (1) corresponds to a shaded area illustrated in FIG. 2. As described above, the parameters RA and RB designate the range of the maximum value DD max in accordance with the minimum value DD min. As represented by Expression (1), the range of the maximum value of driving image data in one frame period is determined in accordance with the minimum value of the driving image data in the one frame period. Thus, it is possible to suppress the change of image data after conversion in one frame period and to improve color reproducibility.

As described above, the parameter WBR designates the luminance of the light source 27 which is used when a white subframe is displayed and is provided in the backlight 25, and takes a value in a range of 0≤WBR≤1. The display unit 20 controls the luminance of the light source 27 in accordance with the parameter WBR, when displaying a white subframe. More specifically, the backlight driving circuit 41 in the display unit 40 controls the luminance of the light source 27 when a white subframe is displayed, to be WBR times the luminance of the light source 27 when other subframes are displayed, in accordance with the parameter WBR.

FIG. 3 is a flowchart illustrating image-data conversion processing. The processing illustrated in FIG. 3 is performed on data of each pixel, which is included in input image data D1. Processing on image data Ri, Gi, and Bi of three colors will be described below on the assumption that red image data (pixel data value), green image data, and blue image data of a pixel, which are included in input image data D1 are respectively set as Ri, Gi, and Bi, and white image data (pixel data value), blue image data, green image data, and red image data of the pixel, which are included in driving image data D2 are respectively set as Wd, Bd, Gd, and Rd.

As illustrated in FIG. 3, the image data Ri, Gi, and Bi of three colors are input to the image data conversion unit 30 (Step S101). Then, the statistical value-and-saturation computation unit 12 obtains the brightness V and the minimum value D min of the image data Ri, Gi, and Bi of the three colors (Step S102). Then, the statistical value-and-saturation computation unit 12 obtains a saturation S by the following expression (2), based on the brightness V and the minimum value D min (Step S103).

S=(V−D min)/V (2)

Here, in the expression (2), S is set to 0 when V is 0.

The distribution ratio-and-coefficient computation unit 32 obtains a distribution ratio WRs by a calculation expression (which will be described later), based on the saturation S and the parameter WRX (Step S104).

Then, the distribution ratio-and-coefficient computation unit 32 performs condition branching in accordance with the parameter GL (Step S301). The distribution ratio-and-coefficient computation unit 32 causes the process to proceed to Step S105 at time of GL=0, and to proceed to Step S302 at time of GL>0. In the former case, the distribution ratio-and-coefficient computation unit 32 obtains the coefficient Ks by the expression (7) (which will be described later) (Step S105).

In the former case, the distribution ratio-and-coefficient computation unit 32 obtains Ks max 1 as a tentative coefficient Ks′ by the expression (15a) (which will be described later) (Step S302). Then, the distribution ratio-and-coefficient computation unit 32 obtains a correction coefficient Kh by the expression (20b) (which will be described later) at time of GL=1, and obtains the correction coefficient Kh by the following expression (20c) (which will be described later) at time of GL=2 (Step S303). The distribution ratio-and-coefficient computation unit 32 outputs a result obtained by multiplying the tentative coefficient Ks′ (=Ks max 1) by the correction coefficient Kh, as the adjustment coefficient Ks (Step S304).

Then, the distribution ratio-and-coefficient computation unit 32 performs condition branching in accordance with the parameter NR (Step S106). The distribution ratio-and-coefficient computation unit 32 causes the process to proceed to Step S110 at time of NR=0, and to proceed to Step S107 at time of NR=1. In the latter case, the distribution ratio-and-coefficient computation unit 32 obtains a value NS based on the coefficient Ks and the parameter WBR (Step S107), obtains a coefficient Ksv based on the brightness V, the coefficient Ks, and the value NS (Step S108), and sets the coefficient Ksv as the coefficient Ks (Step S109).

The driving image-data operation unit 33 obtains image data Wd, Bd, Gd, and Rd of four colors based on the image data Ri, Gi, and Bi of the three colors, the minimum value D min, the distribution ratio WRs, the coefficient Ks, and the parameter WBR by the following expressions (3a) to (3d) (Step S110).

Wd=WRs·D min·Ks·PP/WBR (3a)

Bd=(Bi−WRs·D min)Ks·PP (3b)

Gd=(Gi−WRs·D min)Ks·PP (3c)

Rd=(Ri−WRs·D min)Ks·PP (3d)

Here, in the expressions (3a) to (3d), PP indicates a value (=P/Pmax) obtained by dividing the maximum value P for image data constraint by the maximum value Pmax (=1) which may be set for the image data. PP is also used in a gradation compression method in which the saturation S is not considered. In the following descriptions, PP=1 is assumed. In a case of PP 1, outputting the maximum luminance when S is 0 is not possible.

The driving image-data operation unit 33 obtains image data Wd, Bd, Gd, and Rd of four colors by using the coefficient Ks obtained in Step S105 when NR is 0, and obtains the image data Wd, Bd, Gd, and Rd of the four colors by using the coefficient Ksv obtained in Step S108 when NR is 1. As described above, the image data conversion unit 30 does not perform low-luminance-portion noise handling processing when NR is 0, and performs low-luminance-portion noise handling processing when NR is 1 (details will be described later).

Details of Steps S104 and S105 will be described below. The saturation S and the distribution ratio WRs take values of 0 to 1. The maximum value of blue image data Bd, green image data Gd, and red image data Rd which are included in the driving image data D2 is set as Dd max, and the minimum value thereof is set as Dd min. When PP is 1, Wd, Dd max, and Dd min are given by the following expressions (4a) to (4c), respectively.

Wd=WRs·D min·Ks/WBR (4a)

Dd max=(V−WRs·D min)Ks (4b)

Dd min=(D min−WRs·D min)Ks (4c)

The following expression (5a) is derived by solving the expression of Wd>Dd max in consideration of V=D min/(1−S). The following expression (5b) is derived by solving the expression of Wd<Dd min.

WRs>WBRo/(1−S) (5a)

WRs<WBRo (5b)

Here, in the expressions (5a) and (5b), WBRo satisfies WBR/(1+WBR).

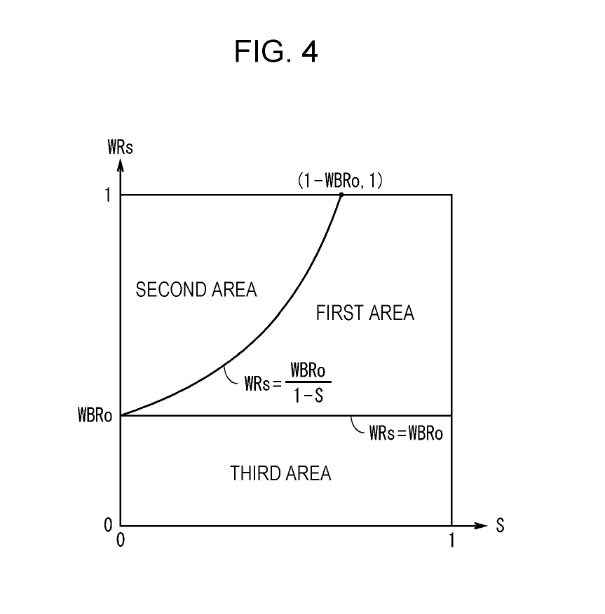

FIG. 4 is a diagram illustrating a range of the saturation S and the distribution ratio WRs. The range of (S, WRs) illustrated in FIG. 4 is divided into a first area in which Dd min<Wd<Dd max is satisfied, a second area in which Dd max<Wd is satisfied, and a third area in which Wd<Dd min is satisfied.

In a case where (S, WRs) is in the first area, DD min is Dd min, and DD max is Dd max. If the expression (1) is solved by substituting D min=V(1−S) into the expression (1), the following expression (6) is obtained.

Ks≤RB/(V×[1−{WRs(1−RA)+RA}(1−S)]) (6)

The coefficient Ks is determined as with the following expression (7) so as to establish the expression (6) even when the brightness V is 1 (maximum value which may be taken by the input image data D1). The expression (7) shows the maximum value which may be taken by the coefficient Ks under a condition of V=1, in a case where (S, WRs) is in the first area.

Ks=RB/[1−{WRs(1−RA)+RA}(1−S)] (7)

In a case where the distribution ratio WRs is determined to cause (S, WRs) to be in the first area, the expression of Dd min<Wd<Dd max is established, and a difference between image data Wd, Bd, Gd, and Rd of four colors included in the driving image data D2 becomes the minimum (even in a case of the maximum, (Dd max−Dd min) is established). In this case, the maximum value which may be taken by the coefficient Ks under a condition in which the distribution ratio WRs is used and V is 1 is given by the expression (7). As (S, WRs) becomes closer to a boundary line between the first and second areas, the white image data Wd approaches the maximum value Dd max. As (S, WRs) becomes closer to a boundary line between the first and third areas, the white image data Wd approaches the minimum value Dd min.

The response rate of the pixel 26 changes depending on the gradation displayed by the pixel 26 (referred to as “a display gradation” below). In the image display device 3, a case where the response rate of the pixel 26 becomes slower as the display gradation increases, and a case where the response rate of the pixel 26 becomes slower as the display gradation decreases are provided. In the former case, the distribution ratio WRs is determined to cause (S, WRs) to be close to the boundary line between the first and second areas, and the white image data Wd is set to approach the maximum value Dd max. In the latter case, the distribution ratio WRs is determined to cause (S, WRs) to be close to the boundary line between the first and third areas, and the white image data Wd is set to approach the minimum value Dd min. As described above, if the white image data Wd is set to approach the maximum value Dd max or the minimum value Dd min in accordance with the response characteristics of the pixel 26, the gradation is displayed with the higher response rate. Thus, it is possible to improve color reproducibility of the image display device 3 by changing image data of the pixel 26 after conversion, fast in each subframe period. The response characteristics of the pixel 26 correspond to optical response characteristics in the liquid crystal panel 24 and can be considered as response characteristics in image display of the display unit 40.

In a case where (S, WRs) is in the second area, DD min is Dd min, and DD max is Wd. Considering the expressions, the expression (4a), the expression (4c), and D min=V(1−S), the following expression (8) by the expression (1) is obtained.

Ks≤WBR·RB/[V(1−S){WRs(1+WBR·RA)−RA·WBR}] (8)

The coefficient Ks is determined as with the following expression (9) so as to establish the expression (8) even when the brightness V is 1 (maximum value which may be taken by the input image data D1). The expression (9) shows the maximum value which may be taken by the coefficient Ks under a condition of V=1, in a case where (S, WRs) is in the second area.

Ks=WBR·RB/[{WRs(1+WBR·RA)−RA·WBR}(1−S)] (9)

In a case where (S, WRs) is in the third area, DD min is Wd, and DD max is Dd max. Considering the expressions, the expression (4a), the expression (4b), and D min=V(1−S), the following expression (10) by the expression (1) is obtained.

Ks≤WBR·RB/[V{WBR−(WBR+RA)WRs(1−S)}] (10)

The coefficient Ks is determined as with the following expression (11) so as to establish the expression (10) even when the brightness V is 1 (maximum value which may be taken by the input image data D1). The expression (11) shows the maximum value which may be taken by the coefficient Ks under a condition of V=1, in a case where (S, WRs) is in the third area.

Ks=WBR·RB/{WBR−(WBR+RA)WRs(1−S)} (11)

Next, details of processing (Step S104) for obtaining the distribution ratio WRs and details of processing (Step S105 and S302 to S304) for obtaining the adjustment coefficient Ks will be described.

<1.3 Method of Determining Distribution Ratio>

The distribution ratio-and-coefficient computation unit 32 has a function of obtaining the distribution ratio WRs based on the saturation S and a function of obtaining the adjustment coefficient Ks based on the saturation S at time of NR=0. The functions changes depending on the parameters WRX, RA, RB, WBR, and WRW stored in the parameter storage unit 31.

The distribution ratio-and-coefficient computation unit 32 obtains the distribution ratio WRs by the following expressions (12a) to (12c).

a) Time of WRX≥(3/2)WRW and 1−S≤(3·WRW)/(2·WRX)WRs=WRX−(WRX/3){(2·WRX)/(3·WRW)}²×(1−S)² (12a)

b) Time of WRX≥(3/2)WRW and 1−S>(3·WRW)/(2·WRX)WRs=WRW/(1−S) (12b)

c) Time of WRX<(3/2)WRW WRs=WRX−(WRX−WRW)×(1−S)² (12c)

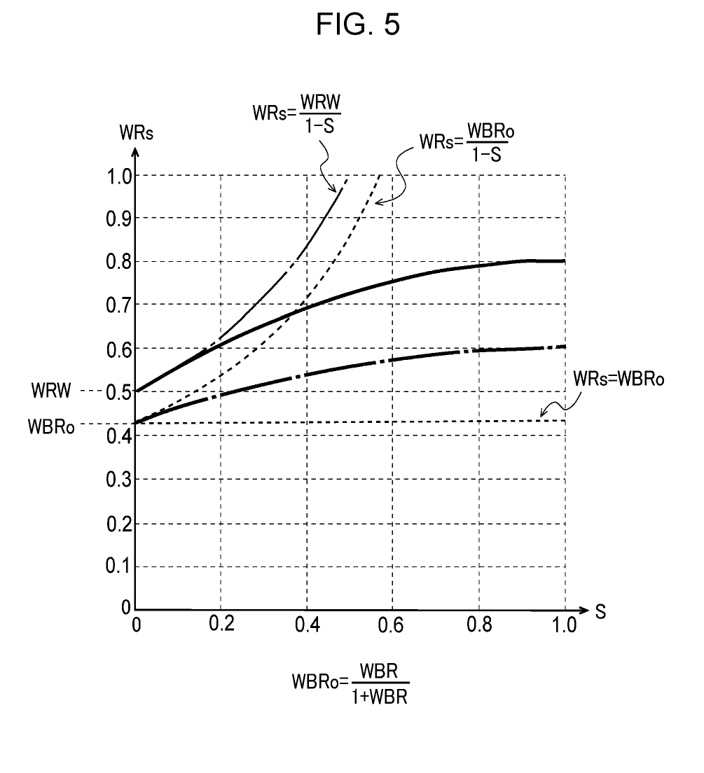

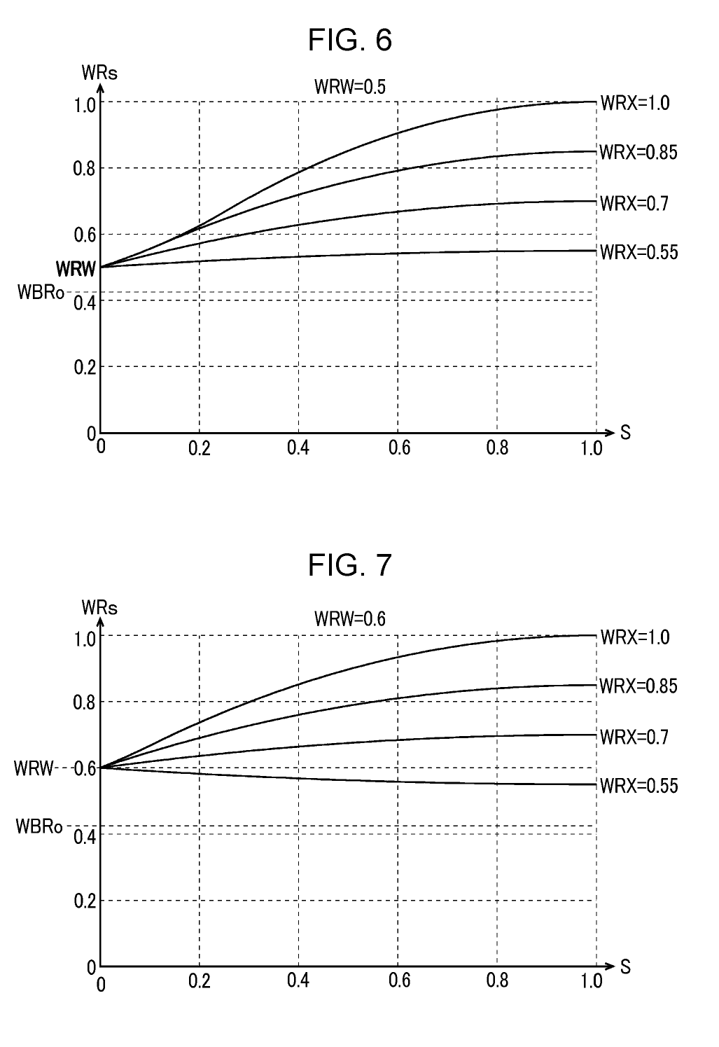

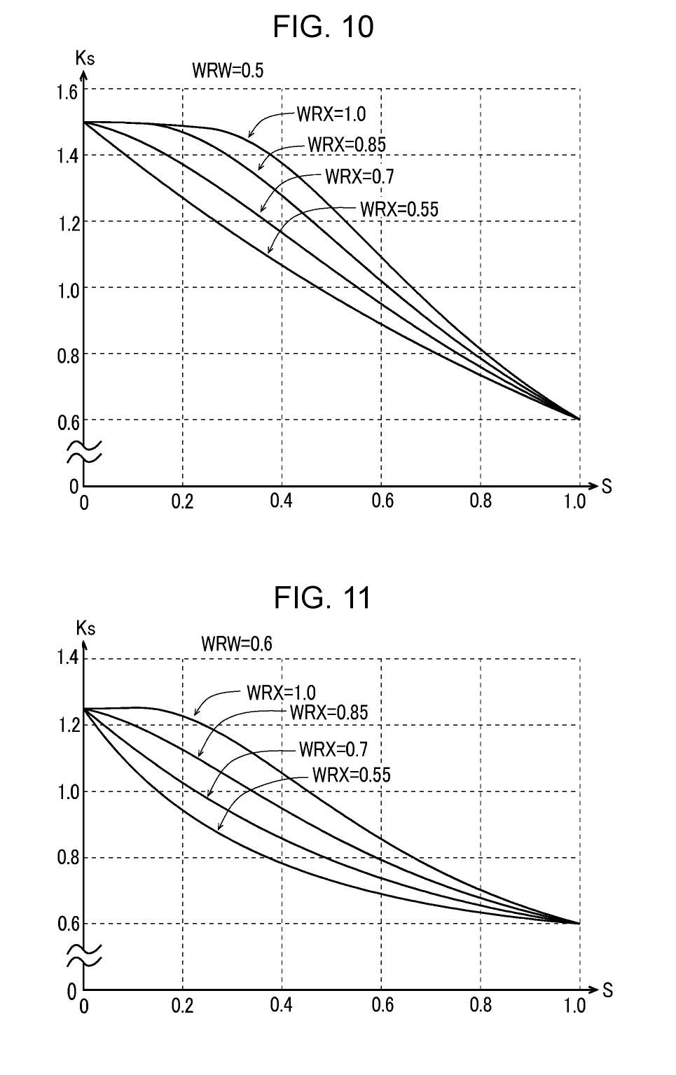

FIG. 5 is a diagram illustrating a graph of the distribution ratio WRs. Here, WRX=0.8, WRW=0.5, and WBR=0.75 are set. FIG. 6 is a graph illustrating the distribution ratio WRs when WRX is 1, 0.85, 0.7, and 0.55 in a case of WRW=0.5. FIG. 7 is a graph illustrating the distribution ratio WRs when WRX is 1, 0.85, 0.7, and 0.55 in a case of WRW=0.6. In a case where a curved line indicating the distribution ratio WRs for the function of the saturation S (simply referred to as “a curved line of the distribution ratio WRs” below) passes through the first area in FIG. 4, for each pixel in an input image, a difference between the maximum value D max and the minimum value D min before image-data conversion processing is equal to a difference between the maximum value DD max and the minimum value DD min in all subframe periods in one frame period after the image-data conversion processing. However, in a case where the curved line of the distribution ratio WRs passes through the third area in FIG. 4, the difference between the maximum value DD max and the minimum value DD min after the image-data conversion processing is greater than that in the related art. Thus, an appropriate response of the liquid crystal panel 24 as the display device has difficulty. In this case, the distribution ratio WRs of a common color subframe is small. Therefore, preferably, the curved line of the distribution ratio WRs is set not to come into the third area in FIG. 4. FIGS. 6 and 7 illustrate the graph of the distribution ratio WRs for the value of the parameter WRX when the parameter WRX satisfies WRX≥WBRo (graphs of the adjustment coefficient Ks illustrated in FIGS. 10, 11, 13, 14, 17, 18, 20, and 21 described later are similar). In the example illustrated in FIGS. 6, 7, and the like, since WBR is 0.75, WBRo=WBR/(1+WBR)=0.429.

In FIG. 5, a solid curved line indicates the graph of the distribution ratio WRs in the embodiment (WRX=0.8, WRW=0.5). The curved line is in the second area when the saturation S is 0 (time of an achromatic color) and is in the first area if the saturation S is greater than a predetermined value. In a case of NR=0 (case where low-luminance-portion noise handling processing is not performed), the value of the adjustment coefficient Ks is obtained to have the maximum value allowed to be taken by the coefficient Ks under the condition in which the distribution ratio WRs is used and the brightness V is 1. Since the distribution ratio WRs and the adjustment coefficient Ks are obtained by the above-described method, for a pixel which is achromatic or has a low saturation, a pixel value in a common-color subframe period is set to be greater than pixel values in other subframe periods ((WRs, S) is in the second area). In addition, for a pixel having a saturation which is greater than a predetermined value, a difference between pixel values in subframe periods in the same frame period (difference of a value between image data Wd, Bd, Gd, and Rd of the four colors) is set to be the minimum ((WRs, S) is in the first area), and the adjustment coefficient Ks is set to have the allowable maximum value.

Since WRs is WRX at time of S=1 (see the expressions (12a) and (12c)), in a case where the response rate of the pixel 26 becomes slower as the display gradation increases, the parameter WRX is set to a value close to 1, and the white image data Wd is set to approach the maximum value Dd max. In a case where the response rate of the pixel 26 becomes slower as the display gradation decreases, the parameter WRX is set to a value close to WBRo=WBR/(1+WBR), and the white image data Wd is set to approach the minimum value Dd min (see FIG. 4). As described above, if the parameter WRX is set in accordance with the response characteristics of the pixel 26 (see FIGS. 6 and 7), it is possible to improve color reproducibility of the image display device 3 by displaying the gradation with the higher response rate.

As illustrated in FIGS. 6 and 7, the function of obtaining the distribution ratio WRs smoothly changes in a range of 0≤S≤1, and an inflection point on this function is not provided. Thus, it is possible to prevent distortion of an image when a gradation image is displayed. In this specification, “the function that smoothly changes” means, for example, a function of a differential coefficient continuously changing. However, it is not limited thereto. The function may be a smooth function without an inflection point. That is, in a case where, even though the differential coefficient of a function is discontinuous, a problem on display does not occur because the extent of discontinuity is sufficiently small, this function may be considered as “the function that smoothly changes”.

<1.4 Method of Determining Adjustment Coefficient>

<1.4.1 Case where Low-Luminance-Portion Noise Handling Processing is not Performed>

Next, a method of determining the adjustment coefficient Ks in a case where low-luminance-portion noise handling processing is not performed (case of NR=0) will be described (see Steps S105 and S302 to S304). In a first example and a second example as follows, regarding parameters RA and RB, RA=0 and RB=1 are assumed. In this case, the expression (1) becomes the expression (14).

DD max≤1 (14)

The expression (14) may be considered as a condition for determining the adjustment coefficient Ks in a range in which a pixel can be displayed in the display unit 40 based on driving image data D2, for each pixel in an input image.

### 1.4.1.1 First Example

The adjustment coefficient Ks according to the first example in the embodiment will be described.

In a case where the distribution ratio WRs is determined to cause (S, WRs) to be in the first area, the expression of Dd min<Wd<Dd max is established, and a difference between image data Wd, Bd, Gd, and Rd of four colors included in the driving image data D2 becomes the minimum ((Dd max−Dd min) is established). In this example, RA=0 and RB=1 are set. In this case, the maximum value (referred to as “a maximum coefficient value in the first area” below) Ks max 1 allowed to be taken by the coefficient Ks under the condition in which the distribution ratio WRs is used and D max=V=1 is set is obtained by substituting RA=0 and RB=1 into the expression (7). That is, the maximum coefficient value Ks max 1 in the first area is given by the following expression (15a). As (S, WRs) becomes closer to a boundary line between the first and second areas, the white image data Wd approaches the maximum value Dd max. As (S, WRs) becomes closer to a boundary line between the first and third areas, the white image data Wd approaches the minimum value Dd min. In a case where the distribution ratio WRs is determined to cause (S, WRs) to be in the second area, Dd max<Wd is established. In this case, the maximum value (referred to as “a maximum coefficient value in the second area” below) Ks max 2 allowed to be taken by the coefficient Ks under the condition in which the distribution ratio WRs is used and D max=V=1 is set is obtained by substituting RA=0 and RB=1 into the expression (9). That is, the maximum coefficient value Ks max 2 in the second area is given by the following expression (15b). In a case where the distribution ratio WRs is determined to cause (S, WRs) to be in the third area, Wd<Dd min is established. In this case, the maximum value (referred to as “a maximum coefficient value in the third area” below) Ks max 3 allowed to be taken by the coefficient Ks under the condition in which the distribution ratio WRs is used and D max=V=1 is set is obtained by substituting RA=0 and RB=1 into the expression (11). That is, the maximum coefficient value Ks max 3 in the third area is given by the following expression (15c). The maximum coefficient value Ks max 1 in the first area and the maximum coefficient value Ks max 3 in the third area are given by the same expression as understood from the following expressions (15a) and (15c).

Ks max 1=1/{1−WRs(1−S)} (15a)

Ks max 2=WBR/{WRs(1−S)} (15b)

Ks max 3=1/{1−WRs(1−S)} (15c)

It is desired that (S, WRs) is in the first area so long as color breakup does not occur. Thus, in this example, correction coefficient Kh which will be described later is introduced, and the adjustment coefficient Ks is defined as the following expression.

Ks=Ks max 1×Kh (16)

In the embodiment, in order to reduce the occurrence of color breakup, (S, WRs) is in the second area at time of an achromatic color. Thus, as described below, the adjustment coefficient Ks is set to be equal to the maximum value Ks max 2 of the adjustment coefficient Ks in the second area when the saturation S is 0. Thus, if values of Ks max 1 and Ks max 2 when the saturation S is 0 (achromatic color) are respectively set as Ks max 10 and Ks max 20, and it is considered that WRs is WRW at time of S=0 (see the expression (12b), the following expressions are obtained.

Ks max 10=1/(1−WRW) (17a)

Ks max 20=WBR/WRW (17b)

A correction coefficient Kh max for causing the adjustment coefficient Ks to be equal to the maximum coefficient value Ks max 20 in the second area in a case of an achromatic color is given by the following expression (18). Since the maximum luminance when the saturation S is 0 is desired, the correction coefficient Kh is set to be equal to or smaller than Kh max represented by the following expression (18).

Kh max=Ks max 20/Ks max 1 (18)

A correction coefficient (referred to as “an achromatic-color correction coefficient” below) Kh0 when the saturation S is 0 is given by the following expression.

Kh0=Ks max 20/Ks max 10 (19)

The correction coefficient Kh can be set with the achromatic-color correction coefficient Kh0, for example, as follows. In the following descriptions, GL and RC are parameters characterizing gradation difference limit processing. A gradation difference is limited in accordance with RC at time of GL>0. The gradation difference limit processing is not performed at time of GL=0.

a) Time of GL=0, Kh=Kh0 (20a)

b) Time of GL=1, Kh=Kh0−(Kh0−RC)×S (20b)

c) Time of GL=2, Kh=Kh0−(Kh0−RC)×S² (20c)

As described above, in this example, the correction coefficient Kh is set such that the adjustment coefficient Ks at time of S=0 (achromatic color) is equal to the maximum value Ks max 2 of the adjustment coefficient Ks in the second area. In addition, in a case where gradation difference limit processing is performed, the correction coefficient Kh is set to be reduced with the saturation S increasing (RC<Kh0 is assumed).

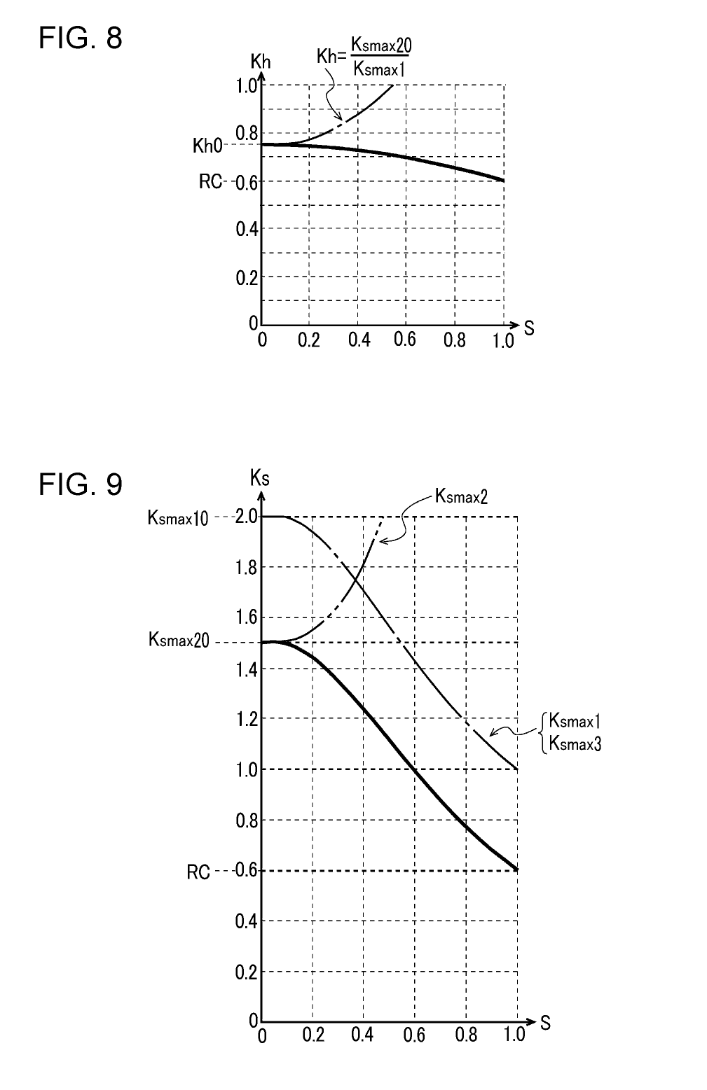

FIG. 8 is a diagram illustrating the correction coefficient Kh in a case of GL=2, along with the correction coefficient Kh max in the expression (18). In FIG. 8, a solid curved line indicates the correction coefficient Kh in this example (see the expression (20c), and a curved line which is a one-dot chain line indicates the correction coefficient Kh max in the expression (18).

In this example, the adjustment coefficient Ks is given by the expression (16). In a case of GL=2, the correction coefficient Kh is given by the expression (20c) with the achromatic-color correction coefficient Kh0 represented by the expression (19). That is, the adjustment coefficient Ks is given by the following expressions (21a) and (21b). The adjustment coefficient Ks changes with respect to the change of the saturation S, so as to be indicated by a solid curved line in FIG. 9.

Ks={Kh0−(Kh−RC)×S^{2}/{1-}WRs(1−S)} (21a)

Kh0=Ks max 20/Ks max 10 (21b)

FIG. 9 is a graph illustrating the adjustment coefficient Ks represented by the expressions (21a) and (21b), along with the maximum coefficient values Ks max 1 to Ks max 3 in the first to third areas. In the graph illustrated in FIG. 9, WRX=0.8, WRW=0.5, RC=0.6, and WBR=0.75 are set. In FIG. 9, the solid curved line indicates the adjustment coefficient Ks in this example. A curved line which is a one-dot chain line indicates the maximum coefficient value Ks max 1 in the first area and the maximum coefficient value Ks max 3 in the third area (see the expressions (15a) and (15c)). A curved line which is a two-dot chain line indicates the maximum coefficient value Ks max 2 in the second area (see the expression (15b). FIG. 10 is a graph illustrating the adjustment coefficient Ks in this example, when WRX is 1, 0.85, 0.7, and 0.55 in a case of WRW=0.5, RC=0.6, and WBR=0.75. FIG. 11 is a graph illustrating the adjustment coefficient Ks in this example, when WRX is 1, 0.85, 0.7, and 0.55 in a case of WRW=0.6, RC=0.6, and WBR=0.75.

As illustrated in FIG. 9, the adjustment coefficient Ks in this example is set such that the adjustment coefficient Ks at time of S=0 (achromatic color) is equal to the maximum value Ks max 2 of the adjustment coefficient Ks in the second area. As illustrated in FIGS. 10 and 11, the function of obtaining the adjustment coefficient Ks smoothly changes in a range of 0≤S≤1, similar to the function of obtaining the distribution ratio WRs.

### 1.4.1.2 Second Example

Next, the adjustment coefficient Ks according to the second example in the embodiment will be described.

In this example, the adjustment coefficient Ks is not set by multiplying the maximum coefficient value Ks max 1 (expression (15a)) in the first area by the correction coefficient Kh as in the first example. Instead, the adjustment coefficient Ks is set such that a point at which a difference between the maximum coefficient value Ks max 1 in the first area and the parameter RC is proportionally divided (internally-dividing point between Ks max 1 and RC) corresponds to the adjustment coefficient Ks, and the adjustment coefficient Ks when the saturation S is 0 is equal to the maximum coefficient value Ks max 2 in the second area. That is, the adjustment coefficient Ks in this example is a value obtained by proportionally dividing the maximum coefficient value Ks max 1 in the first area and the parameter RC at a ratio of Ks max 10−Ks max 20:Ks max 20−RC. The adjustment coefficient Ks in this example is given by the following expression.

Ks=Ks max 1−(Ks max 1−RC)×(Ks max 10−Ks max 20)/(Ks max 10−RC) (22)

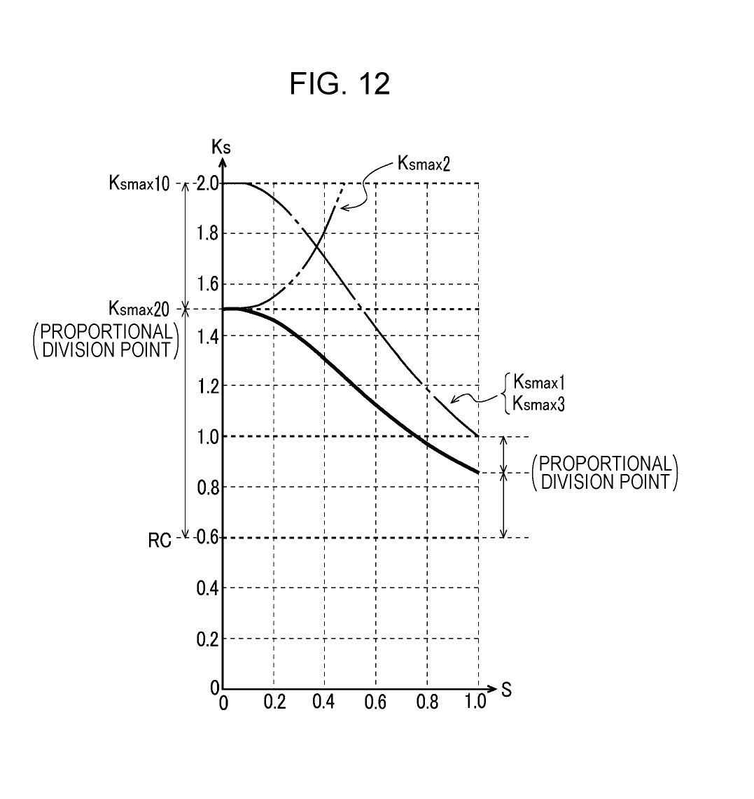

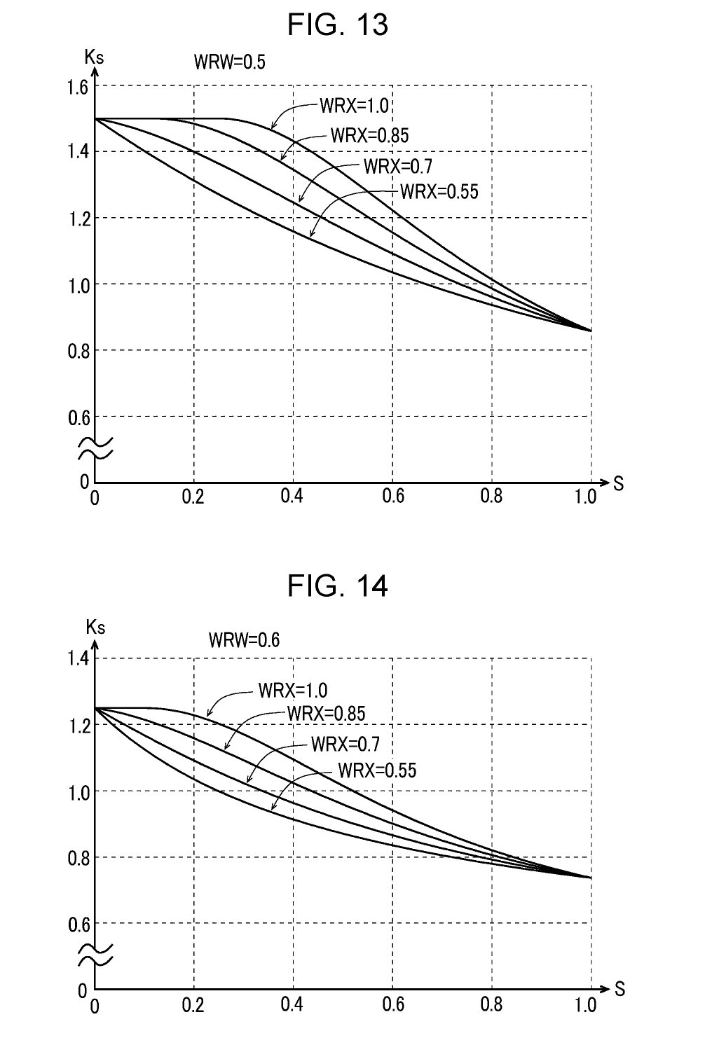

FIG. 12 is a graph illustrating the adjustment coefficient Ks represented by the expression (22), along with the maximum coefficient values Ks max 1 to Ks max 3 in the first to third areas. In the graph illustrated in FIG. 12, WRX=0.8, WRW=0.5, RC=0.6, and WBR=0.75 are also set. In FIG. 12, a solid curved line indicates the adjustment coefficient Ks in this example. A curved line which is a one-dot chain line indicates the maximum coefficient value Ks max 1 in the first area and the maximum coefficient value Ks max 3 in the third area (see the expressions (15a) and (15c)). A curved line which is a two-dot chain line indicates the maximum coefficient value Ks max 2 in the second area (see the expression (15b). FIG. 13 is a graph illustrating the adjustment coefficient Ks in this example, when WRX is 1, 0.85, 0.7, and 0.55 in a case of WRW=0.5, RC=0.6, and WBR=0.75. FIG. 14 is a graph illustrating the adjustment coefficient Ks in this example, when WRX is 1, 0.85, 0.7, and 0.55 in a case of WRW=0.6, RC=0.6, and WBR=0.75.

As illustrated in FIG. 12, similar to the first example, the adjustment coefficient Ks in this example is set such that the adjustment coefficient Ks at time of S=0 (achromatic color) is equal to the maximum value Ks max 2 of the adjustment coefficient Ks in the second area. As illustrated in FIGS. 13 and 14, the function of obtaining the adjustment coefficient Ks smoothly changes in a range of 0≤S≤1, similar to the function of obtaining the distribution ratio WRs.

### 1.4.1.3 Third Example

Next, the adjustment coefficient Ks according to a third example in the embodiment will be described.

This example is different from the first example and the second example in that the adjustment coefficient Ks is determined without limiting the parameters RA and RB to RA=0 and RB=1, so as to satisfy the expression (1). The expression (1) represents that the maximum value DD max of driving image data D2 in one frame period is equal to or smaller than a value of the minimum value DD min, which is given by a linear expression (see FIG. 2).

As described above, the maximum value (maximum coefficient value in the first area) Ks max 1 allowed to be taken by the adjustment coefficient Ks under a condition of V=1 in a case where (S, WRs) is in the first area (case of Dd min<Wd<Dd max) is given by the expression (7), and this is represented again by the following expression (23a). The maximum value (maximum coefficient value in the second area) Ks max 2 allowed to be taken by the adjustment coefficient Ks under the condition of V=1 in a case where (S, WRs) is in the second area (case of Wd>Dd max) is given by the expression (9), and this is represented again by the following expression (23b). The maximum value (maximum coefficient value in the third area) Ks max 3 allowed to be taken by the adjustment coefficient Ks under the condition of V=1 in a case where (S, WRs) is in the third area (case of Wd<Dd min) is given by the expression (11), and this is represented again by the following expression (23c).

Ks max 1=RB/[1−{WRs(1−RA)+RA}(1−S)] (23a)

Ks max 2=WBR·RB/[{WRs(1+WBR·RA)−RAW·BR}(1−S)] (23b)

Ks max 3=WBR·RB/{WBR−(WBR+RA)WRs(1−S)} (23c)

In this example, similar to the first example, the adjustment coefficient Ks is defined by the following expression (24) with the maximum coefficient value Ks max 1 in the first area and the correction coefficient Kh. In addition, the correction coefficient Kh is set such that the adjustment coefficient Ks is equal to the maximum coefficient value Ks max 2 in the second area at time of S=0 (achromatic color).

Ks=Ks max 1×Kh (24)

In this example, if values of Ks max 1 and Ks max 2 at the time of S=0 (achromatic color) are respectively set as Ks max 10 and Ks max 20, the following expressions are obtained.

Ks max 10=RB/[1−{WRs(1−RA)+RA}] (25a)

Ks max 20=WBR·RB/[{WRs(1+WBR·RA)−RA·WBR}] (25b)

Similar to the first example, the correction coefficient (achromatic-color correction coefficient) Kh0 at the time of S=0 (achromatic color) is given by the following expression (26).

Kh0=Ks max 20/Ks max 10 (26)

The correction coefficient Kh in this example can be set with the achromatic-color correction coefficient Kh0, as with the following expression (27a) to (27c).

a) Time of GL=0, Kh=Kh0 (27a)

b) Time of GL=1, Kh=Kh0−(Kh0−RC)×S (27b)

c) Time of GL=2, Kh=Kh0−(Kh0−RC)×S² (27c)

As described above, in this example, similar to the first example, the correction coefficient Kh is set such that the adjustment coefficient Ks at time of S=0 (achromatic color) is equal to the maximum value Ks max 2 of the adjustment coefficient Ks in the second area. In addition, in a case where gradation difference limit processing is performed, the correction coefficient Kh is set to be reduced with the saturation S increasing (RC<Kh0 is assumed).

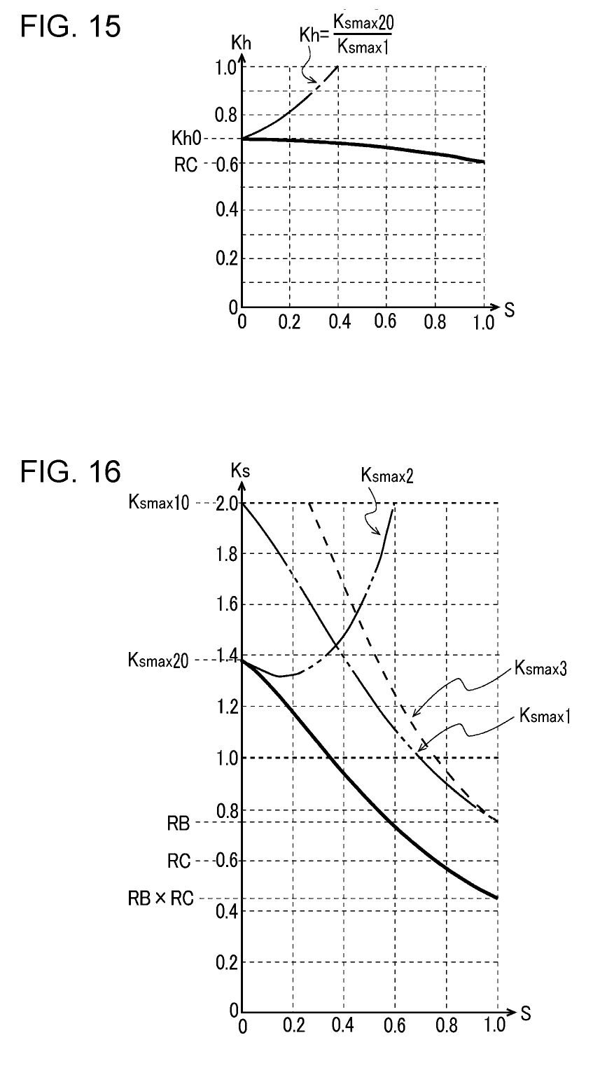

FIG. 15 is a diagram illustrating the correction coefficient Kh in a case of GL=2, along with the correction coefficient Kh max=Ks max 20/Ks max 1 in the above-described expression (18). In FIG. 15, a solid curved line indicates the correction coefficient Kh in this example (see the expression (27c), and a curved line which is a one-dot chain line indicates the correction coefficient Kh max in the expression (18).

In this example, the adjustment coefficient Ks is given by the expression (24). In a case of GL=2, the correction coefficient Kh is given by the expression (27c) with the achromatic-color correction coefficient Kh0 represented by the expression (26). That is, the adjustment coefficient Ks is given by the following expressions (28a) and (28b). The adjustment coefficient Ks changes with respect to the change of the saturation S, so as to be indicated by a solid curved line in FIG. 16.

Ks=RB{Kh0−(Kh0−RC)×S²}/[1−{WRs(1−RA)+RA}(1−S)] (28a)

Kh0=Ks max 20/Ks max 10 (28b)

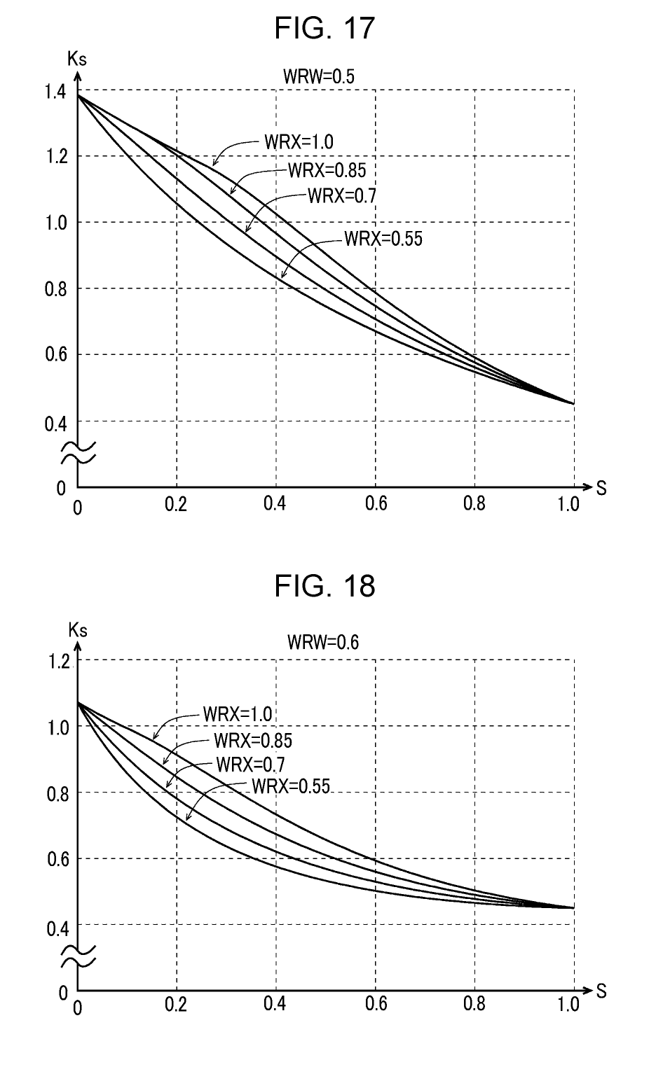

FIG. 16 is a graph illustrating the adjustment coefficient Ks represented by the expressions (28a) and (28b), along with the maximum coefficient values Ks max 1 to Ks max 3 in the first to third areas. In the graph illustrated in FIG. 16, WRX=0.8, WRW=0.5, RC=0.6, and WBR=0.75 are also set. In FIG. 16, a solid curved line indicates the adjustment coefficient Ks in this example. A curved line which is a one-dot chain line indicates the maximum coefficient value Ks max 1 in the first area (see the expression (23a)). A curved line which is a two-dot chain line indicates the maximum coefficient value Ks max 2 in the second area (see the expression (23b)). A curved line which is a broken line indicates the maximum coefficient value Ks max 3 in the third area (see the expression (23c)). FIG. 17 is a graph illustrating the adjustment coefficient Ks in this example, when WRX is 1, 0.85, 0.7, and 0.55 in a case of WRW=0.5, RC=0.6, and WBR=0.75. FIG. 18 is a graph illustrating the adjustment coefficient Ks in this example, when WRX is 1, 0.85, 0.7, and 0.55 in a case of WRW=0.6, RC=0.6, and WBR=0.75.

As illustrated in FIG. 16, the adjustment coefficient Ks in this example is also set such that the adjustment coefficient Ks at time of S=0 (achromatic color) is equal to the maximum value Ks max 2 of the adjustment coefficient Ks in the second area. As illustrated in FIGS. 17 and 18, the function of obtaining the adjustment coefficient Ks smoothly changes in a range of 0≤S≤1, similar to the function of obtaining the distribution ratio WRs.

### 1.4.1.4 Fourth Example

Next, the adjustment coefficient Ks according to a fourth example in the embodiment will be described.

In this example, similar to the third example, the maximum coefficient value Ks max 1 in the first area, the maximum coefficient value Ks max 2 in the second area, and the maximum coefficient value Ks max 3 in the third area are given by the expressions (23a), (23b), and (23c), respectively. However, this example is different from the third example in which the correction coefficient Kh is introduced, but is similar to the second example. That is, the adjustment coefficient Ks is set such that a point at which a difference between the maximum coefficient value Ks max 1 in the first area and the parameter RC is proportionally divided (internally-dividing point between Ks max 1 and RC) corresponds to the adjustment coefficient Ks, and the adjustment coefficient Ks when the saturation S is 0 is equal to the maximum coefficient value Ks max 2 in the second area. That is, the adjustment coefficient Ks in this example is given by the following expression.

Ks=Ks max 1−(Ks max 1−RC)×(Ks max 10−Ks max 20)/(Ks max 10−RC) (29)

Here, Ks max 1, Ks max 10, and Ks max 20 in the expression (29) are given by the expressions (23a), (25a), and (25b), respectively.

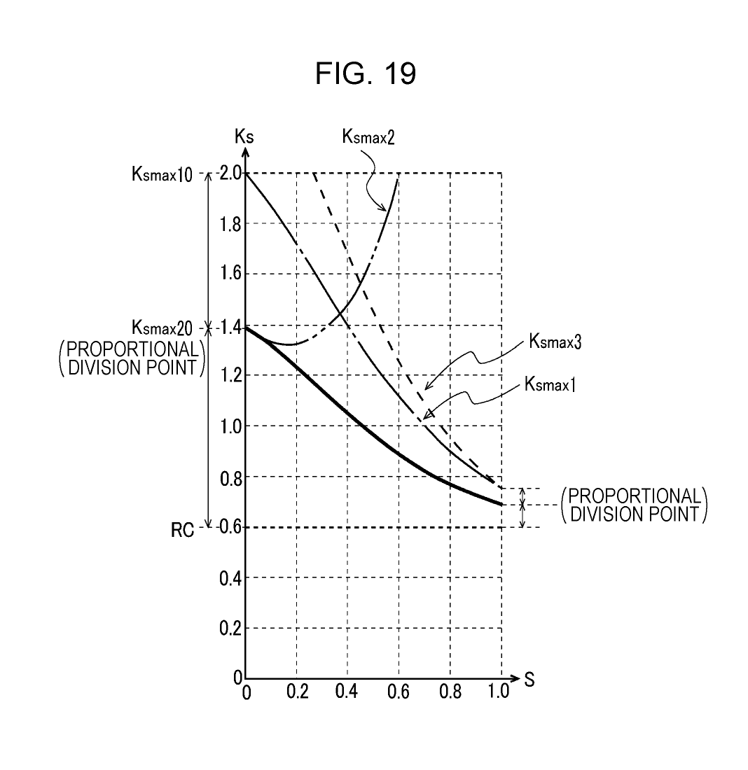

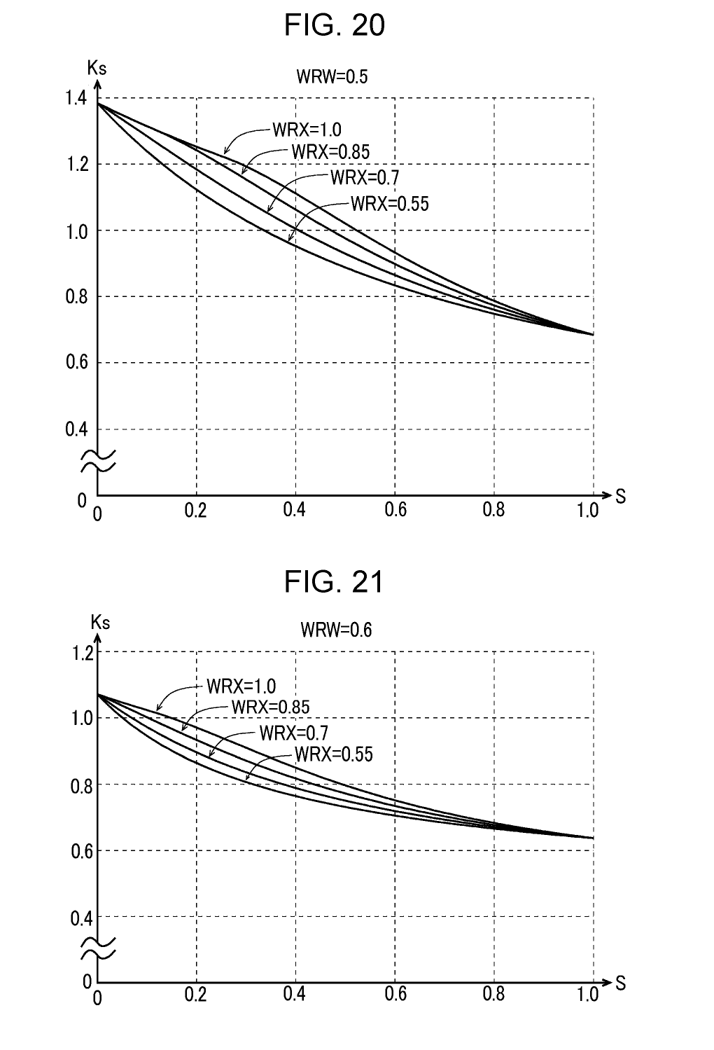

FIG. 19 is a graph illustrating the adjustment coefficient Ks represented by the expression (29), along with the maximum coefficient values Ks max 1 to Ks max 3 in the first to third areas. In the graph illustrated in FIG. 19, WRX=0.8, WRW=0.5, RC=0.6, and WBR=0.75 are also set. In FIG. 19, a solid curved line indicates the adjustment coefficient Ks in this example. A curved line which is a one-dot chain line indicates the maximum coefficient value Ks max 1 in the first area (see the expression (23a)). A curved line which is a two-dot chain line indicates the maximum coefficient value Ks max 2 in the second area (see the expression (23b)). A curved line which is a broken line indicates the maximum coefficient value Ks max 3 in the third area (see the expression (23c)). FIG. 20 is a graph illustrating the adjustment coefficient Ks in this example, when WRX is 1, 0.85, 0.7, and 0.55 in a case of WRW=0.5, RC=0.6, and WBR=0.75. FIG. 21 is a graph illustrating the adjustment coefficient Ks in this example, when WRX is 1, 0.85, 0.7, and 0.55 in a case of WRW=0.6, RC=0.6, and WBR=0.75.

As illustrated in FIG. 19, the adjustment coefficient Ks in this example is also set such that the adjustment coefficient Ks at time of S=0 (achromatic color) is equal to the maximum value Ks max 2 of the adjustment coefficient Ks in the second area. As illustrated in FIGS. 20 and 21, the function of obtaining the adjustment coefficient Ks smoothly changes in a range of 0≤S≤1, similar to the function of obtaining the distribution ratio WRs.

<1.4.2 Case where Low-Luminance-Portion Noise Handling Processing is Performed>

Next, a method of determining the adjustment coefficient Ks in a case where low-luminance-portion noise handling processing is performed (case of NR=1) will be described (see Steps S107 to S109 in FIG. 3).

When NR is 1, the distribution ratio-and-coefficient computation unit 32 obtains the value NS by the following expression (30) in Step S107 and obtains the coefficient Ksv by the following expression (31) in Step S108.

NS=NB−NB{Ks−(1+WBR)}²/(1+WBR)² (30)

Ksv=(Ks−NS)V+NS (31)

NB in the expression (30) is given by the following expression.

NB=(1+WBR)²/{2(1+WBR)−1} (32)

If the expression (30) is substituted into the expression (31), a calculation expression (referred to as “Expression E” below) of obtaining the coefficient Ksv based on the brightness V, the coefficient Ks, and the parameter WBR is obtained. If V is set to 0 in Expression E, the function of obtaining the coefficient Ksv when V is 0 is obtained. Similarly, if V is set to 1 in Expression E, the function of obtaining the coefficient Ksv when V is 1 is obtained. If V is set to Vx (here, 0<Vx<1) in Expression E, the function of obtaining the coefficient Ksv when V is Vx is obtained. The coefficient Ksv at time of V=0 is equal to the value NS (Ksv=NS), and the coefficient Ksv at time of V=1 is equal to the coefficient Ks (Ksv=Ks). The coefficient Ksv at time of V=Vx has a value obtained by dividing the coefficient Ks and the value NS at a ratio of (1−Vx):Vx.

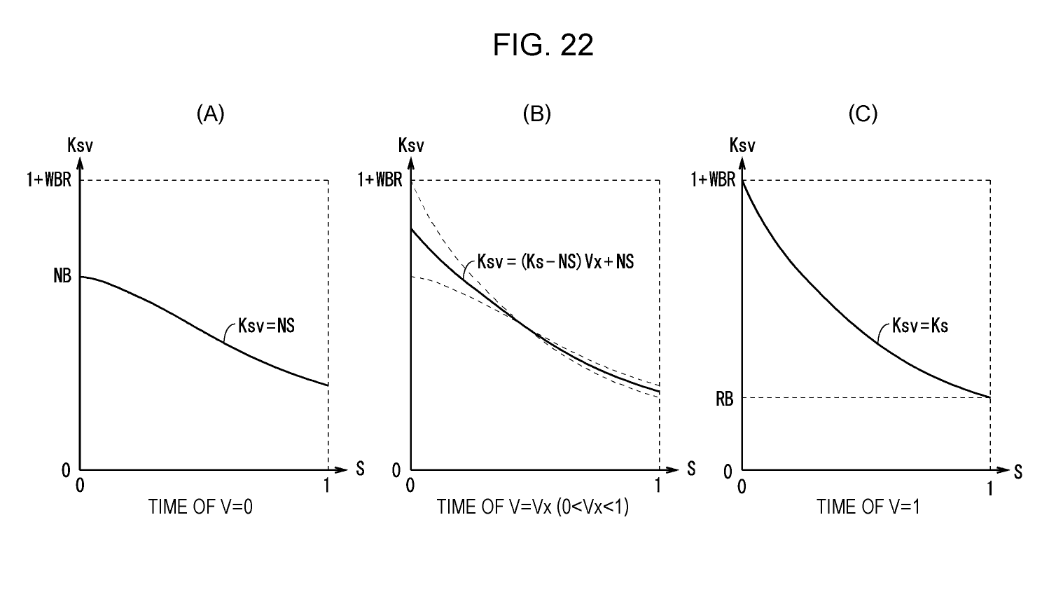

FIG. 22 is a diagram illustrating a graph of the coefficient Ksv. FIGS. 22(A) to 22(C) illustrate graphs at time of V=0, V=Vx, and V=1, respectively. As illustrated in FIG. 22, when the brightness V is set to a certain value, the coefficient Ksv decreases as the saturation S becomes greater, regardless of the value of the brightness V. Therefore, the coefficient Ksv becomes the maximum at time of S=0, and becomes the minimum at time of S=1. The difference between the minimum value and the maximum value of the coefficient Ksv at time of V=0 is smaller than the difference between the minimum value and the maximum value of the coefficient Ksv at time of V=1. The difference between the minimum value and the maximum value of the coefficient Ksv decrease as the brightness V becomes smaller.

As described above, since the difference between the minimum value and the maximum value of the coefficient Ksv decreases as the brightness V becomes smaller, the amount of the coefficient Ksv changing with respect to the amount of the saturation S changing is small when the brightness V is small. Thus, if low-luminance-portion noise handling processing is performed, it is possible to suppress an occurrence of a situation in which the color of a pixel largely changes between the pixel and the adjacent pixel when the luminance is low, and to suppress the occurrence of noise at a low-luminance portion of a display image.

In the image display device 3, if the saturation S and the hue H are the same, it is necessary that the luminance of a pixel 26 increases as the input image data D1 becomes greater (that is, gradation properties are held). In order to hold the gradation properties, if the saturation S is the same, it is necessary that a result obtained by performing amplification and compression processing on the brightness V increases as the brightness V of the input image data D1 becomes greater. Thus, at least, it is necessary that a result obtained by multiplying the brightness V by the coefficient Ksv at time of 0<V<1 is smaller than a result obtained by multiplying the brightness V (=1) by the coefficient Ksv (=Ks) at time of V=1. With Ksv·V≤Ks, the following expression (33) is obtained.

Ksv≤Ks/V (33)

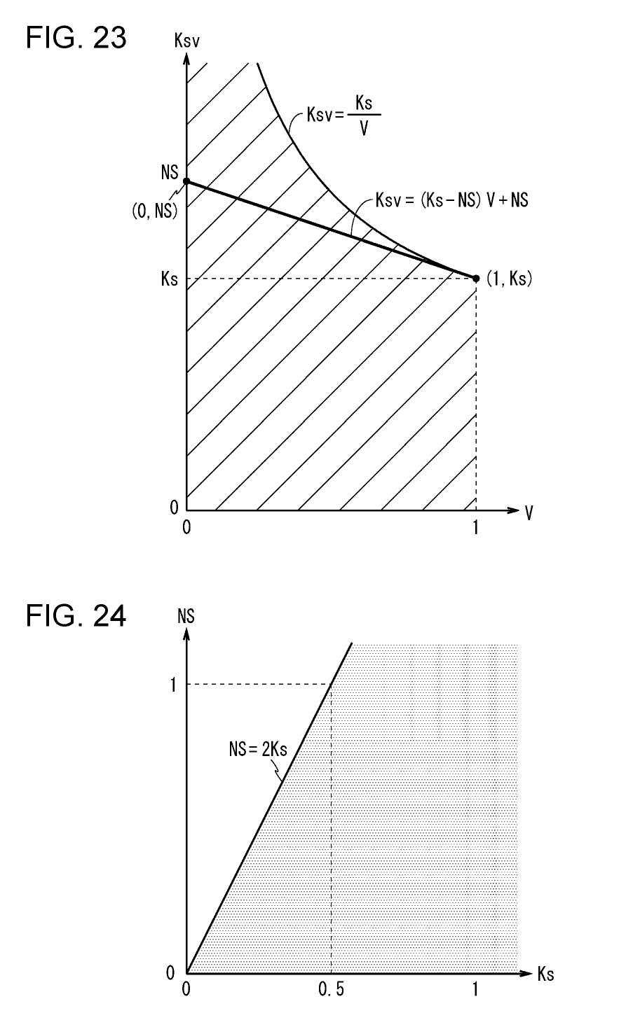

A range satisfying the expression (33) corresponds to a shaded area illustrated in FIG. 23. The function of obtaining the coefficient Ksv based on the brightness V is determined such that the graph of the function is in the shaded area illustrated in FIG. 23. As described above, the distribution ratio-and-coefficient computation unit 32 obtains the coefficient Ksv by the expression (31). As illustrated in FIG. 23, the graph of the coefficient Ksv passes through two points (0, NS) and (1, Ks).

In order to cause an inequation obtained by substituting the expression (31) with the expression (33) to be established in a range of 0<V<1, the slope of a straight line shown by the expression (31) may be equal to or greater than the slope of a tangent line at a point (1, Ks) of the function of Ksv=Ks/V. Thus, with Ks−NS≥−Ks, the following expression (34) is obtained. A range satisfying the expression (34) corresponds to a dot pattern area illustrated in FIG. 24.

NS≤2Ks (34)

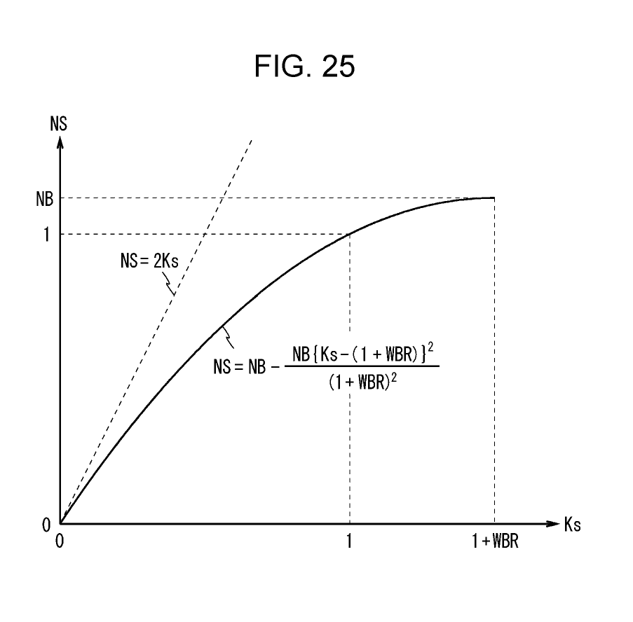

FIG. 25 is a diagram illustrating a graph of the value NS. The graph illustrated in FIG. 25 passes through three points (0, 0), (1, 1), and (1+WBR, NB). The slope of a tangent line at a point (0, 0) of the function of obtaining the value NS satisfies the expression of 2NB/(1+WBR)=(2+2WBR)/(1+2WBR), and is equal to or smaller than 2 in a range of 0≤WBR≤1. Thus, the graph illustrated in FIG. 25 is in the range illustrated in FIG. 24. Accordingly, since the value NS is obtained by the expression (31), if the saturation S and the hue H are the same, the result obtained by performing amplification and compression processing on the brightness V increases as the brightness V of the input image data D1 becomes greater. Thus, in a case where low-luminance-portion noise handling processing is performed, the luminance of a pixel 26 increases as the input image data D1 becomes greater, and thus it is possible to hold the gradation properties.

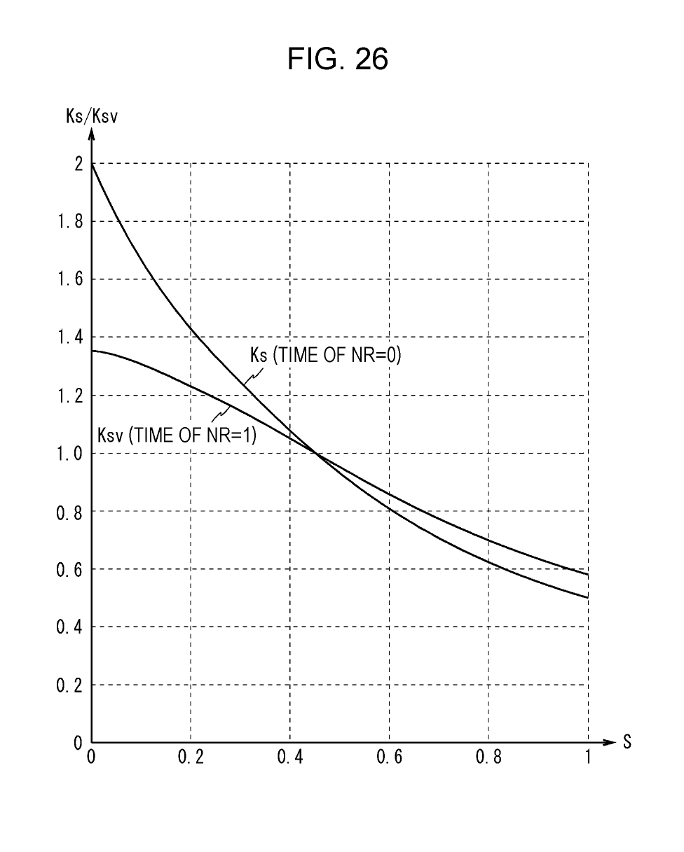

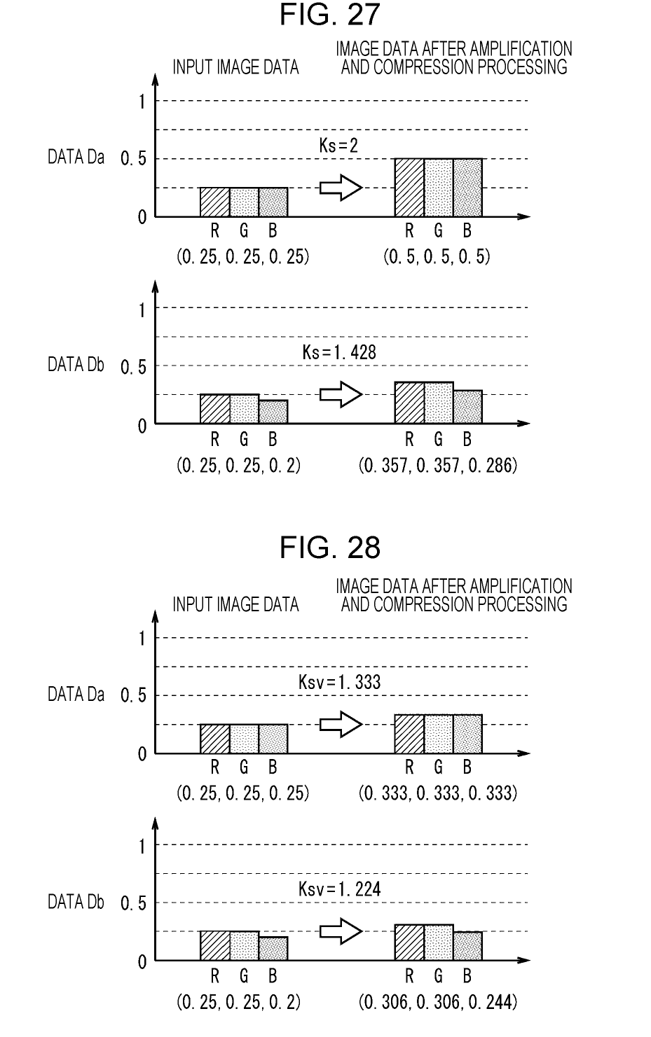

The effects of low-luminance-portion noise handling processing will be described with reference to FIGS. 26 to 28. FIG. 26 is a diagram illustrating a graph of the coefficient in the image display device 3. FIG. 26 illustrates the graph of the coefficient Ks obtained in Step S105 at time of NR=0 and the graph of the coefficient Ksv obtained in Step S108 at time of NR=1. Here, WRX=WBR=1 and RA=RB=0.5 are set. FIG. 27 is a diagram illustrating an example of image-data conversion processing in a case where low-luminance-portion noise handling processing is not performed (at time of NR=0), in the image display device 3. FIG. 28 is a diagram illustrating an example of image-data conversion processing in a case where the low-luminance-portion noise handling processing is performed (at time of NR=1), in the image display device 3.

Here, as an example, a case where red image data, green image data, and blue image data which are included in input image data D1 corresponds to (0.25, 0.25, 0.25) and a case where the red image data, green image data, and blue image data corresponds to (0.25, 0.25, 0.2) are considered (the former is referred to as “data Da” below, and the latter is referred to as “data Db” below). Regarding data Da, S is 0, and V is 0.25. Regarding data Db, S is 0.2, and V is 0.25.

When NR is 0, and S is 0, Ks is 2. When NR is 0, and S is 0.2, Ks is 1.428 (see FIG. 26). Thus, in a case where low-luminance-portion noise handling processing is not performed (FIG. 27), amplification and compression processing of multiplying the data Da by Ks=2 is performed, and image data after the amplification and compression processing corresponds to (0.5, 0.5, 0.5). Amplification and compression processing of multiplying the data Db by Ks=1.428 is performed, and image data after the amplification and compression processing corresponds to (0.357, 0.357, 0.286). A difference between the data Da and the data Db is small. However, in a case where the low-luminance-portion noise handling processing is not performed, a large difference occurs between a result obtained by performing amplification and compression processing on the data Da and a result obtained by performing amplification and compression processing on the data Db.

When NR is 1, and S is 0, Ks is 1.333. When NR is 1, and S is 0.2, Ks is 1.224 (see FIG. 26). Thus, in a case where low-luminance-portion noise handling processing is performed (FIG. 28), amplification and compression processing of multiplying the data Da by Ks=1.333 is performed, and image data after the amplification and compression processing corresponds to (0.333, 0.333, 0.333). Amplification and compression processing of multiplying the data Db by Ks=1.224 is performed, and image data after the amplification and compression processing corresponds to (0.306, 0.306, 0.245). In a case where the low-luminance-portion noise handling processing is performed, the difference between the result obtained by performing amplification and compression processing on the data Da and the result obtained by performing amplification and compression processing on the data Db is smaller than that in a case where the low-luminance-portion noise handling processing is not performed.

It is assumed that a pixel driven based on the data Da is adjacent to a pixel driven based on the data Db. In a case where the low-luminance-portion noise handling processing is not performed, the difference of the color between the two pixels is large, and thus noise occurs at a low-luminance portion of a display image. Since the low-luminance-portion noise handling processing is performed, the difference of the color between the two pixels is reduced, and thus it is possible to suppress the occurrence of noise at the low-luminance portion of the display image.

<1.5 Effects>

As described above, in Step S110, the driving image-data operation unit 33 obtains image data Wd, Bd, Gd, and Rd of the four colors by the expressions (3a) to (3d), based on the image data Ri, Gi, and Bi of the three colors, the minimum value D min, the distribution ratio WRs, the adjustment coefficient Ks, and the parameter WBR. Here, a color shown by the image data Ri, Gi, or Bi of the three colors is referred to as a color before conversion, and a color shown by the image data Wd, Bd, Gd, or Rd of the four colors is referred to as “colors after conversion”. When the two colors are expressed in an HSV color space, brightness V is different between the two colors, the hue H is the same between the two colors, and the saturation S is the same between the two colors. As described above, in image-data conversion processing in the image data conversion unit 30, for each pixel, the hue H holds the same value and the saturation S holds the same value in the HSV color space, between the input image data D1 and the driving image data D2.

As described above, the image display device 3 according to the embodiment is a field sequential type image display device which includes the image data conversion unit 30 that obtains driving image data D2 corresponding to a plurality of subframes (white, blue, green, and red subframes) including a common color subframe (white subframe), based on input image data D1 corresponding to a plurality of primary colors (red, green, and blue), and the display unit 40 that displays the plurality of subframes based on the driving image data D2, in one frame period. The image data conversion unit 30 performs conversion processing (image-data conversion processing) of converting first image data (input image data D1) corresponding to a plurality of primary colors into second image data (driving image data D2) corresponding to a plurality of subframes, for each pixel 26. In the conversion processing, for each pixel 26, the hue H and the saturation S of the first image data and the hue H and the saturation S of the second image data in the HSV color space are held to be respectively equal to each other. The image data conversion unit 30 computes an adjustment coefficient Ks used in the conversion processing, and performs the conversion processing using the adjustment coefficient Ks. In a case where low-luminance-portion noise handling processing is performed, the adjustment coefficient Ks varies depending on a brightness V and has a value causing a brightness after the conversion processing to increase as the brightness V becomes greater if the saturations S are equal to each other (see Steps S107 to S109). As the brightness V becomes smaller, the difference between the minimum value of the adjustment coefficient (adjustment coefficient Ks at time of S=1) and the maximum value thereof (adjustment coefficient Ks at time of S=0) decreases (see FIG. 22).

As described above, since the adjustment coefficient Ks is obtained to vary depending on the brightness V and to have a value causing a brightness after the amplification and compression processing to increase as the brightness V becomes greater if the saturation S is the same. Thus, it is possible to hold the gradation properties. It is possible to suppress the occurrence of noise at a low-luminance portion of a display image by reducing the amount of the adjustment coefficient Ks changing with respect to the amount of the saturation S changing, when the brightness V is small. Thus, according to the image display device 3 according to the embodiment, it is possible to suppress the occurrence of noise at a low-luminance portion of a display image while gradation properties are held.

The image data conversion unit 30 obtains the distribution ratio WRs indicating a value distributed to a common color subframe and the adjustment coefficient Ks used in amplification and compression processing, performs conversion processing using the distribution ratio WRs and the adjustment coefficient Ks. When the saturation S is greater than a predetermined value, the image data conversion unit obtains the distribution ratio WRs for each pixel such that second image data corresponding to the common color subframe is in a range of the minimum value Dd min of the second image data corresponding to other subframes to the maximum value Dd max thereof (see FIGS. 4 and 5). Thus, it is possible to suppress a change of the image data after the conversion, in one frame period, and to improve color reproducibility of the image display device. The image data conversion unit 30 obtains the distribution ratio WRs and the adjustment coefficient Ks by the functions which smoothly change depending on the saturation S (see FIGS. 6, 10, 13, 17, 20, and the like). Thus, it is possible to prevent distortion of an image when a gradation image is displayed.

In the conversion processing in the image data conversion unit 30, the range of the maximum value DD max of the second image data in one frame period is determined in accordance with the minimum value DD min of the second image data in one frame period (see the expression (1) and FIG. 2). Thus, it is possible to suppress a change of the image data after the conversion, in one frame period, and to improve color reproducibility of the image display device.

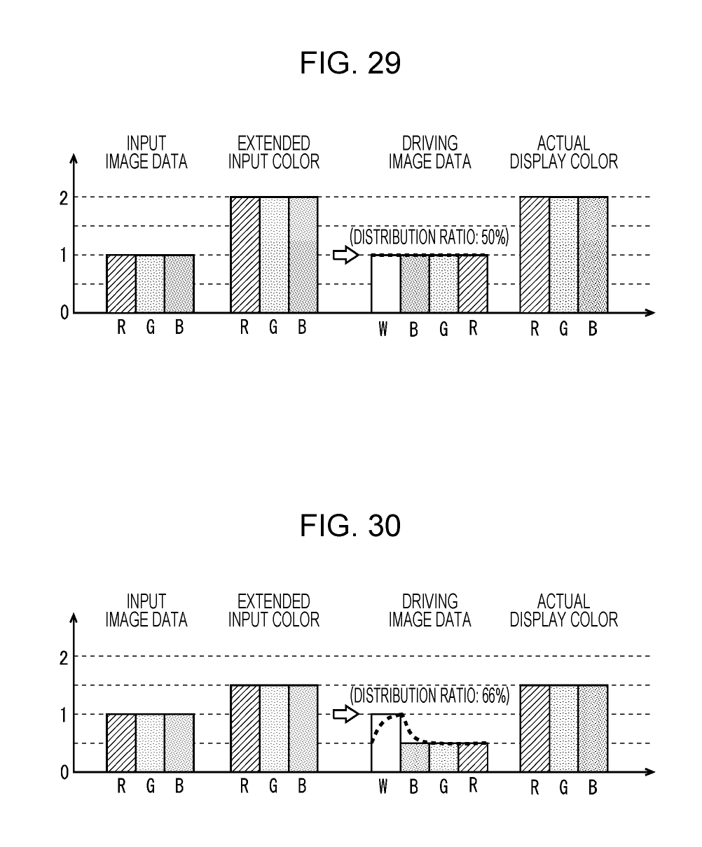

In a case where the saturation S is close to 0 (saturation which indicates an achromatic color or is close to the achromatic color), color breakup occurs frequently. However, in the embodiment, in this case, (S, WRs) is in the second area, and Wd>Dd max is established (see FIGS. 4 and 5). In a case where input image data D1 is, for example, data of maximum white display, if light utilization efficiency of the liquid crystal panel 24 as the display device is set to be the maximum, the distribution ratio WRs becomes 50% as illustrated in FIG. 29. However, it may be determined that allowing color breakup in the maximum white display is not possible at this distribution ratio. In the embodiment, in a case of S=0 (achromatic color), Wd>Dd max is established. Since the distribution ratio WRs becomes, for example, 66% as illustrated in FIG. 30, the occurrence of color breakup is suppressed even in the maximum white display. When the saturation S is greater than a predetermined value, (S, WRs) is in the first area, and Dd min<Wd<Dd max is established (see FIGS. 4 and 5 and the expressions (12a) and (12c)). Thus, as described above, it is possible to improve color reproducibility. In addition, the decrease of light utilization efficiency is also suppressed in comparison to a configuration in the related art, in which the distribution ratio of the common color subframe is set to the maximum value of 1.0. As described above, according to the embodiment, in the field sequential image display device, it is possible to prevent the occurrence of color breakup with preventing the decrease of light utilization efficiency and to perform image display having high color reproducibility.

In a configuration in which luminance amplification is performed with a common color subframe, amplification is performed more easily as the saturation S approaches 0. Thus, a color space after the amplification is extended in a luminance direction as the saturation approaches 0. As a result, in a case where the saturation is close to 0, gradation skipping may occur in a display image by emphasizing the original gradation difference. On the contrary, in the embodiment, since (S, WRs) is in the second area in FIG. 4, and Wd>Dd max is established in a case of S=0 (achromatic color), the transmittance of the liquid crystal panel 24 in each subframe period does not become the maximum. As a result, in comparison to a case where the transmittance of the liquid crystal panel 24 in each subframe period becomes the maximum in a case of S=0 (achromatic color), the maximum luminance decreases, but the occurrence of gradation skipping in a display image is suppressed. That is, according to the embodiment, it is possible to adequately adjust the amount of amplified luminance which causes the occurrence of gradation skipping to be suppressed while the luminance is amplified, by the adjustment coefficient Ks.

The image data conversion unit 30 includes the parameter storage unit 31 that stores a parameter used in the conversion processing. The parameter storage unit 31 stores the first parameter (parameter WRX) in accordance with the response characteristics of a pixel 26 provided in the display unit 40. Thus, it is possible to improve color reproducibility by setting a suitable first parameter in accordance with the response characteristics of the display unit 40.

The parameter storage unit 31 stores the second parameters (parameters RA and RB) in addition to the first parameter (parameter WRX). The second parameters are provided for designating the range of the maximum value DD max of the second image data in one frame period in accordance with the minimum value DD min of the second image data in one frame period. Since the suitable first parameter is set in accordance with the response characteristics of the display unit 40 and the maximum value DD max of the driving image data D2 in one frame period is limited in accordance with the minimum value DD min of the driving image data D2 in one frame period by using the second parameter, it is possible to improve color reproducibility.

The parameter storage unit 31 stores the third parameter (parameter WBR) in addition to the first parameter (parameter WRX) and the second parameter (parameters RA and RB). The third parameter is provided for designating the luminance of the light source 27 provided in the display unit 40 when a common color subframe (white subframe) is displayed. The display unit 40 controls the luminance of the light source 27 in accordance with the third parameter, when displaying the common color subframe. Thus, according to the image display device 3, it is possible to improve color reproducibility by using the first and second parameters, and to reduce heat generated by the light source 27 by controlling the luminance of the light source 27 of when a common color subframe is displayed, with the third parameter.

The parameter storage unit 31 stores a fourth parameter (parameter WRW) prepared to allow the distribution ratio WRs at time of S=0 (achromatic color) to be set to be equal to or greater than WBR/(1+WBR), in order to more reduce the occurrence of color breakup, in addition to the first parameter (parameter WRX), the second parameter (parameters RA and RB), and the third parameter (parameter WBR). With the parameter WRW, it is possible to suppress the occurrence of color breakup even in the maximum white display by increasing the distribution ratio so as to establish Wd>Dd max when the saturation is close to 0.

The image data conversion unit 30 performs the conversion processing on normalized luminance data (input image data D1). Thus, it is possible to accurately perform the conversion processing. The input image data D1 corresponds to the red, green, and blue colors. The driving image data D2 corresponds to red, green, blue, and white subframes. The common color subframe is a white subframe. Thus, in the image display device that displays subframes of three primary colors and the white color based on input image data D1 corresponding to the three primary colors, it is possible to suppress the occurrence of noise at a low-luminance portion of a display image while the gradation properties are held.

### 2. Second Embodiment

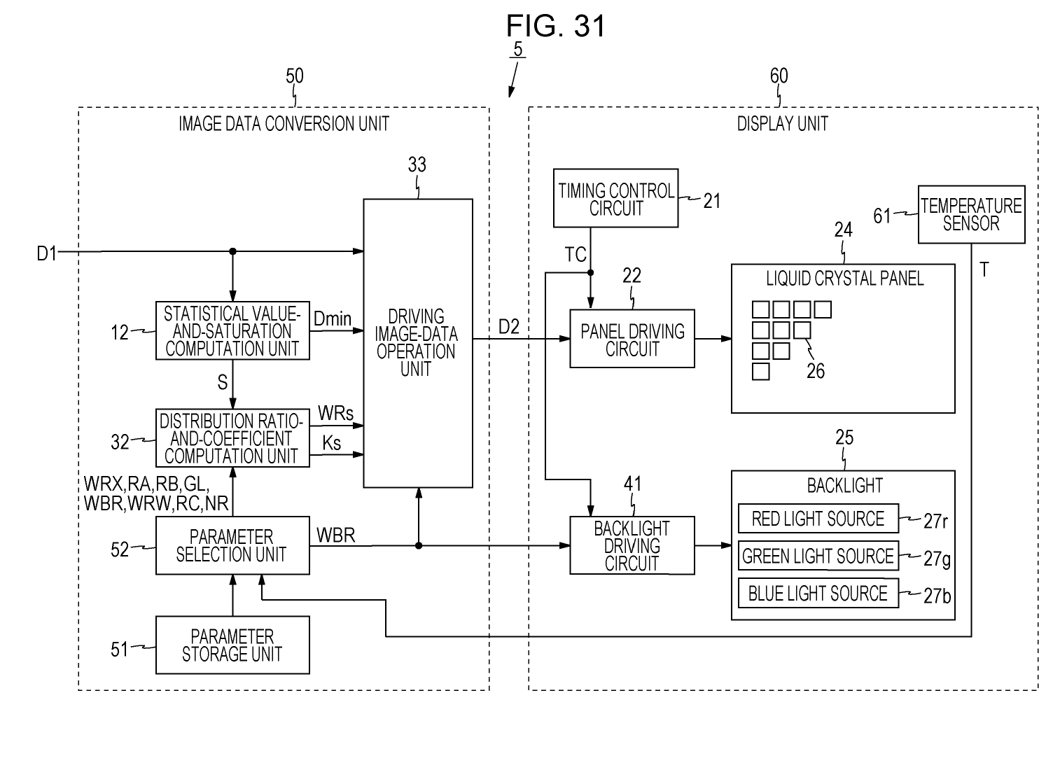

FIG. 31 is a block diagram illustrating a configuration of an image display device according to a second embodiment. An image display device 5 illustrated in FIG. 31 includes an image data conversion unit 50 and a display unit 60. The image data conversion unit 50 is obtained by adding a parameter selection unit 52 to the image data conversion unit 30 according to the first embodiment and replacing the parameter storage unit 31 with a parameter storage unit 51. The display unit 60 is obtained by adding a temperature sensor 61 to the display unit 40 according to the first embodiment. Differences from the first embodiment will be described below.

The temperature sensor 61 is provided in the display unit 60 and measures the temperature T of the display unit 60. The temperature sensor 61 is provided, for example, in the vicinity of the liquid crystal panel 24. The temperature T measured by the temperature sensor 61 is input to the parameter selection unit 52.

The parameter storage unit 51 stores a plurality of values for the parameters WRX, RA, RB, WBR, WRW, and RC, in accordance with the temperature. The parameter selection unit 52 selects values from the plurality of values stored in the parameter storage unit 51, in accordance with the temperature T measured by the temperature sensor 61. Then, the parameter selection unit outputs the selected values as the parameters WRX, RA, RB, WBR, WRW, and RC. The parameters WRX, RA, RB, WBR, WRW, and RC output from the parameter selection unit 52 are input to the distribution ratio-and-coefficient computation unit 32. The parameter WBR is also input to the backlight driving circuit 41. The parameters GL and NR pass through the parameter selection unit 52 from the parameter storage unit 51 and then are input to the distribution ratio-and-coefficient computation unit 32.

As described above, in the image display device 5 according to the embodiment, the image data conversion unit 50 includes the parameter storage unit 51 that stores the parameters WRX, RA, RB, WBR, WRW, GL, RC, and NR used in conversion processing (image-data conversion processing). The display unit 60 includes the temperature sensor 61. The parameter storage unit 51 stores the plurality of values for the parameters WRX, RA, RB, WBR, WRW, and RC in accordance with the temperature. The image data conversion unit 50 selects values depending on the temperature T measured by the temperature sensor 61, among the plurality of values stored in the parameter storage unit 51. The selected values are used in the conversion processing. Thus, according to the image display device 5, the conversion processing is performed based on the parameters WRX, RA, RB, WBR, WRW, and RC in accordance with the temperature T of the display unit 60. Accordingly, it is possible to improve color reproducibility even in a case where the response characteristics of the display unit 60 change depending on the temperature.

### 3. Third Embodiment

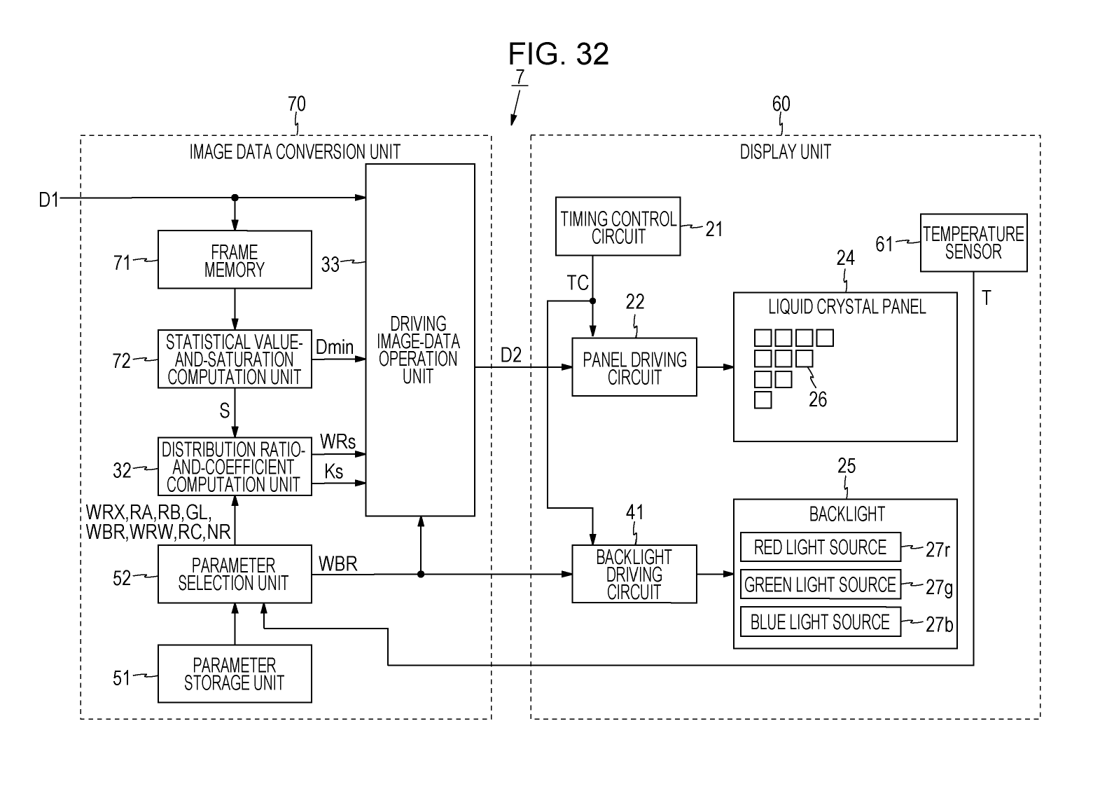

FIG. 32 is a block diagram illustrating a configuration of an image display device according to a third embodiment. An image display device 7 illustrated in FIG. 32 includes an image data conversion unit 70 and a display unit 60. The image data conversion unit 70 is obtained by adding a frame memory 71 to the image data conversion unit 50 according to the second embodiment and replacing the statistical value-and-saturation computation unit 12 with a statistical value-and-saturation computation unit 72. Differences from the second embodiment will be described below.

Input image data D1 including red image data, green image data, and blue image data is input to the image display device 7. The frame memory 71 stores input image data D1 corresponding to one frame or a plurality of frames.

Similar to the statistical value-and-saturation computation unit 12, the statistical value-and-saturation computation unit 72 obtains the maximum value D max, the minimum value D min, and the saturation S based on the input image data D1, for each pixel. At this time, the statistical value-and-saturation computation unit 72 obtains, for each pixel, the maximum value D max, the minimum value D min, and the saturation S based on the input image data D1 which has been stored in the frame memory 71 and corresponds to a plurality of pixels.

For example, when obtaining the saturation S of a certain pixel, the statistical value-and-saturation computation unit 72 may obtain the saturation for a plurality of pixels in the vicinity of this pixel, and obtain an average value, the maximum value, or the minimum value of a plurality of saturations which have been obtained. The statistical value-and-saturation computation unit 72 may perform weighting to the saturation in the neighboring pixel, in accordance with a distance or the like from the neighboring pixel and then perform calculation. Thus, since the saturation S is smoothly changed in a spatial direction or the value of the adjustment coefficient Ks in accordance with the saturation S is reduced, it is possible to reduce disharmony of an image, which occurs by a luminance difference varying depending on the saturation S. The statistical value-and-saturation computation unit 72 may obtain the saturation S by applying a filter operation to the saturation obtained for the previous frame and the saturation obtained for the current frame. The statistical value-and-saturation computation unit 72 may perform weighting to the saturation of the previous frame in accordance with a time difference or the like from the current frame, and then perform calculation. Thus, since the saturation S is smoothly changed in a time direction or the value of the adjustment coefficient Ks in accordance with the saturation S is reduced, it is possible to reduce disharmony of an image, which occurs by a luminance difference in the time direction, which varies depending on the saturation S. The statistical value-and-saturation computation unit 72 obtains the maximum value D max and the minimum value D min with the similar methods.

As described above, in the image display device 7 according to the embodiment, the image data conversion unit 70 includes the frame memory 71 that stores first image data (input image data D1), and performs conversion processing based on the first image data corresponding to a plurality of pixels stored in the frame memory 71, for each pixel. Thus, according to the image display device 7, it is possible to prevent a rapid change of the distribution ratio WRs and the adjustment coefficient Ks and to prevent an occurrence of a situation in which the color of a pixel 26 rapidly changes in the spatial direction or the time direction.

### 4. Modification Example

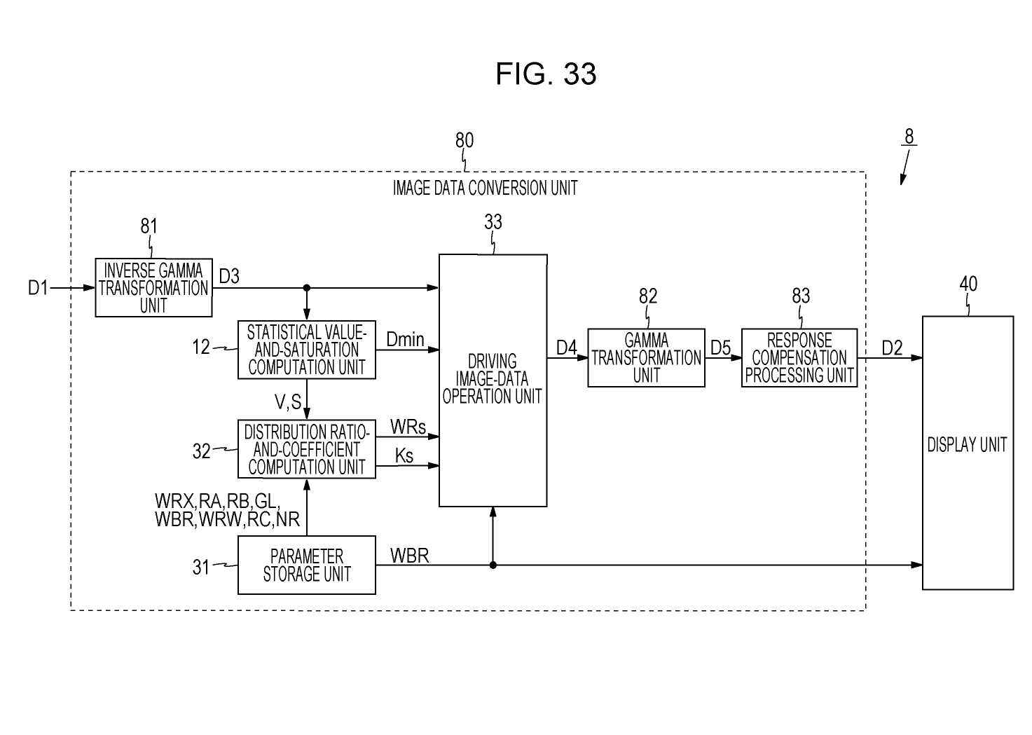

Regarding the image display device in the embodiments, the following modification example can be made. FIG. 33 is a block diagram illustrating a configuration of an image display device according to a modification example of the first embodiment. In an image display device 8 illustrated in FIG. 33, an image data conversion unit 80 is obtained by adding an inverse gamma transformation unit 81, a gamma transformation unit 82, and a response compensation processing unit 83 to the image data conversion unit 30 according to the first embodiment.

Input image data D1 to be input to the image display device 8 is gradation data before inverse gamma transformation is performed. The inverse gamma transformation unit 81 performs inverse gamma transformation on the input image data D1 so as to obtain image data D3 after inverse gamma transformation. The parameter storage unit 31, the statistical value-and-saturation computation unit 12, the distribution ratio-and-coefficient computation unit 32, and the driving image-data operation unit 33 perform kinds of processing similar to those in the first embodiment, on the image data D3 after the inverse gamma transformation, respectively. Thus, image data D4 before gamma transformation is obtained. The gamma transformation unit 82 performs gamma transformation on the image data D4 before the gamma transformation, so as to obtain image data D5. The response compensation processing unit 83 performs response compensation processing on the image data D5 so as to obtain driving image data D2. In the response compensation processing unit 83, overdrive processing (may also be referred to as “overshoot processing”) of compensating for insufficiency of the response rate of a pixel 26.

In the image display device 8 according to the modification example, the image data conversion unit 80 obtains driving image data D2 in a manner that conversion processing (image-data conversion processing) of converting first image data (image data D3 after the inverse gamma transformation) corresponding to a plurality of primary colors into second image data (image data D4 before the gamma transformation) corresponding to a plurality of subframes is performed for each pixel, and response compensation processing is performed on image data D5 after the conversion processing has been performed. Thus, according to the image display device 8, it is possible to display a desired image even in a case where the response rate of the display unit 60 is slow.

The image data conversion unit 80 includes the inverse gamma transformation unit 81, the gamma transformation unit 82, and the response compensation processing unit 83. Instead, the image data conversion unit may include the inverse gamma transformation unit 81 and the gamma transformation unit 82, but may not include the response compensation processing unit 83. Alternatively, the image data conversion unit may include the response compensation processing unit 83, but may not include the inverse gamma transformation unit 81 and the gamma transformation unit 82. At least one of the inverse gamma transformation unit 81 and the gamma transformation unit 82, and the response compensation processing unit 83 may be added to the image data conversion unit according to the first embodiment. The gamma transformation may be performed after the response compensation processing. In this case, the response compensation processing is performed on image data output from the driving image-data operation unit. The gamma transformation is performed on image data after the response compensation processing.

In the first to third embodiments, the distribution ratio-and-coefficient computation unit obtains the coefficient Ks so as to satisfy the expression (1), and thus the expression of RB=1-RA is satisfied (see FIG. 2). Instead, the distribution ratio-and-coefficient computation unit may obtain the coefficient Ks such that the minimum value DD min and the maximum value DD max are in a certain limited range which has been set in a range satisfying 0≤DD min≤1 and 0≤DD max≤1. For example, the boundary of the limited range illustrated in FIG. 2 is a straight line. However, the boundary of the limited range may be a curved line or a polygonal line having an inflection point. Here, the border of the limited range is preferably a straight line or a curved line.

In the first to third embodiments, the image display device that obtains the distribution ratio WRs and the coefficients Ks and Ksv by specific calculation expressions is described. However, as the calculation expressions of obtaining the distribution ratio WRs and the coefficients Ks and Ksv, expressions other than the calculation expressions described in the embodiments may be provided. For example, as the calculation expression of obtaining the distribution ratio WRs, a calculation expression which has been known from the past may be used. As the calculation expression of obtaining the coefficient Ksv, any calculation expression satisfying the expression (33) may be used.

Hitherto, the image display devices according to the first to third embodiments and the modification example thereof are described. Any combination of the features of the image display devices according to the first to third embodiments and the modification example thereof as long as the features do not contradict the properties thereof can constitute image display devices according to various modification examples.

In the first to third embodiments, an image is displayed in a manner that the liquid crystal panel 24 that causes light from the backlight 25 as the light source unit to be transmitted therethrough controls the transmittance of the liquid crystal panel 24 used as a display panel. However, the present invention is not limited to a field sequential display device using a transmission type optical modulator as with the liquid crystal panel 24. The present invention can also be applied to a field sequential display device using a reflection type optical modulator. For example, the present invention can also be applied to a field sequential projection type display device in which a reflection type liquid crystal panel called as a liquid crystal-on-silicon (LCOS) is used as an optical modulator. The present invention can be applied to a field sequential image display device other than a liquid crystal display apparatus, for example, a spontaneous-emission image display device such as an organic electroluminescence (EL) display device, a see-through image display device having a function of seeing through the back of the display panel, or the like.

In the first to third embodiments, each frame period is configured with primary-color subframe periods of the blue color, the green color, and the red color and the white subframe period (subframe having a white color which is a common color of blue, green, and red) as the common-color subframe period. Instead, each frame period may be configured with a subframe period of another primary color and the common-color subframe period. In this specification, it is assumed that “the common color” means a color including all color components of primary colors corresponding to primary-color subframe periods in each frame period, and the ratio of the color components is not limited. From a viewpoint that the occurrence of color breakup is suppressed by the common color subframe, a common-color subframe period (for example, a subframe period of a yellow color configured with red and green) corresponding to another color configured with two primary colors may be used as the white subframe period as the common-color subframe period. From a similar viewpoint, any color other than black, for example, “yellowish green”, “red”, or “red having the half luminance” can be caused to correspond to the common-color subframe period instead of “white” or “yellow”.

### 5. Others

This application claims priority right based on Japanese Patent Application No. 2016-192943 entitled “field sequential image display device and image display method” filed on Sep. 30, 2016, and the contents of this Japanese application are included in the present application by reference.

### REFERENCE SIGNS LIST

3, 5, 7, 8 IMAGE DISPLAY DEVICE
30, 50, 70, 80 IMAGE DATA CONVERSION UNIT
40, 60 DISPLAY UNIT
31, 51 PARAMETER STORAGE UNIT
12, 72 STATISTICAL VALUE-AND-SATURATION COMPUTATION UNIT
32 DISTRIBUTION RATIO-AND-COEFFICIENT COMPUTATION UNIT
33 DRIVING IMAGE-DATA OPERATION UNIT
21 TIMING CONTROL CIRCUIT
22 PANEL DRIVING CIRCUIT
41 BACKLIGHT DRIVING CIRCUIT
24 LIQUID CRYSTAL PANEL
25 BACKLIGHT
26 PIXEL
27 LIGHT SOURCE
52 PARAMETER SELECTION UNIT
61 TEMPERATURE SENSOR
71 FRAME MEMORY
81 INVERSE GAMMA TRANSFORMATION UNIT
82 GAMMA TRANSFORMATION UNIT
83 RESPONSE COMPENSATION PROCESSING UNIT

1. A field sequential image display device in which a plurality of subframe periods including a plurality of primary-color subframe periods respectively corresponding to a plurality of primary colors and at least one common-color subframe period is included in each frame period, the device comprising:
an image data conversion unit that receives input image data corresponding to the plurality of primary colors and generates driving image data corresponding to the plurality of subframe periods from the input image data by obtaining a pixel data value of each of the plurality of subframe periods for each pixel of an input image represented by the input image data, based on the input image data; and
a display unit that displays an image based on the driving image data,
wherein the image data conversion unit
performs conversion processing of generating the driving image data from the input image data such that a pixel data value of the achromatic pixel in the common-color subframe period is set to be greater than any of pixel data values in the plurality of primary-color subframe periods in a case where a hue and a saturation of each pixel of the input image in an HSV space are maintained, and the input image includes an achromatic pixel, and that a pixel data value of the pixel in the common-color subframe period is set to be greater than a minimum value and smaller than a maximum value of the pixel data values in the plurality of primary-color subframe periods in a case where the input image includes the pixel having the saturation greater than a predetermined value.

2. The image display device according to claim 1,
wherein the image data conversion unit
determines a distribution ratio in accordance with the saturation of the pixel, for each pixel in the input image, the distribution ratio defined as a ratio of the pixel data value in the common-color subframe period in the driving image data to the maximum value allowed to be taken by the pixel data value in the common-color subframe period,
determines an adjustment coefficient to be multiplied by a value of the pixel, based on the pixel data values in the plurality of subframe periods in a range in which the pixel is allowed to be displayed in the display unit, in accordance with the saturation of the pixel, for each pixel in the input image, and
generates the driving image data by obtaining the pixel data value of each of the plurality of subframe periods from the value of the pixel based on the adjustment coefficient and the distribution ratio, for each pixel in the input image.

3. The image display device according to claim 1,
wherein the image data conversion unit
determines a distribution ratio in accordance with the saturation of the pixel, for each pixel in the input image, the distribution ratio defined as a ratio of a display light quantity of a common color component, which is to be emitted in the common-color subframe period to a display light quantity of the common color component, which is to be emitted in one frame period for displaying the pixel,
determines an adjustment coefficient to be multiplied by a value of the pixel, based on the pixel data values in the plurality of subframe periods in a range in which the pixel is allowed to be displayed in the display unit, in accordance with the saturation of the pixel, for each pixel in the input image, and
generates the driving image data by obtaining the pixel data value of each of the plurality of subframe periods from the value of the pixel based on the adjustment coefficient and the distribution ratio, for each pixel in the input image.

4. The image display device according to claim 2,
wherein the image data conversion unit determines the adjustment coefficient such that a maximum value is linearly limited with respect to a minimum value among the pixel data values in the plurality of subframe periods, for each pixel in the input image.

5. The image display device according to claim 2,
wherein the image data conversion unit
assumes a function of the saturation, which indicates a tentative coefficient for obtaining the adjustment coefficient and a function of the saturation, which indicates a correction coefficient to be multiplied by the tentative coefficient, and
obtains a multiplication result of the tentative coefficient and the correction coefficient based on the saturation of the pixel for each pixel in the input image, as the adjustment coefficient.

6. The image display device according to claim 5,
wherein the tentative coefficient is set to indicate a maximum value allowed to be taken by the adjustment coefficient in a case where the distribution ratio is set such that the pixel data value of the pixel in the input image in the common-color subframe period is greater than a minimum value of the pixel data values in the plurality of primary-color subframe periods and is smaller than a maximum value thereof, and
the correction coefficient is set such that the multiplication result of the tentative coefficient and the correction coefficient is equal to the maximum value allowed to be taken by the adjustment coefficient in a case where the distribution ratio is set to cause the pixel data value of the pixel in the common-color subframe period to be greater than any pixel data value in the plurality of primary-color subframe periods, when the pixel in the input image is achromatic.

7. The image display device according to claim 2,
wherein the image data conversion unit
assumes a function of the saturation, which indicates a tentative coefficient for obtaining the adjustment coefficient, and
obtains a value corresponding to a proportional division point of a difference between the tentative coefficient based on the saturation of the pixel and a predetermined value, as the adjustment coefficient, for each pixel in the input image.

8. The image display device according to claim 7,
wherein the tentative coefficient is set to indicate a maximum value allowed to be taken by the adjustment coefficient in a case where the distribution ratio is set such that the pixel data value of the pixel in the input image in the common-color subframe period is smaller than a maximum value of the pixel data values in the plurality of primary-color subframe periods and is greater than a minimum value thereof, and
the image data conversion unit obtains the adjustment coefficient in a manner that the image data conversion unit proportionally divides a difference between the tentative coefficient and the predetermined value such that the proportional division point corresponds to a maximum value allowed to be taken by the adjustment coefficient when the pixel in the input image is achromatic in a case where the distribution ratio is set to cause the pixel data value of the pixel in the input image in the common-color subframe period to be greater than any pixel data value in the plurality of primary-color subframe periods.

9. The image display device according to claim 2,
wherein the image data conversion unit
includes a first function which includes at least one first parameter and is the function of the saturation, which indicates the distribution ratio and a second function which includes at least one second parameter and is the function of the saturation, which indicates the adjustment coefficient, and
is capable of adjusting the distribution ratio and the adjustment coefficient with the at least one first parameter and the at least one second parameter.

10. The image display device according to claim 9,
wherein the display unit includes
a light source unit that emits light having a corresponding color in each subframe period,
a light modulation unit that causes the light from the light source unit to be transmitted therethrough or be reflected thereby,
a light-source-unit driving circuit that drives the light source unit to irradiate the light modulation unit with the light having the corresponding color in each subframe period, and
a light-modulation-unit driving circuit that controls transmittance or reflectance in the light modulation unit such that an image of the corresponding color in each subframe period is displayed,
the at least one first parameter and the at least one second parameter include a light emission control parameter, and
the light-source-unit driving circuit controls emission luminance of a common color component in the light source unit based on the light emission control parameter.

11. The image display device according to claim 10,
wherein the image data conversion unit determines the distribution ratio of an achromatic pixel in the input image to be greater than WBR/(1+WBR) when the light emission control parameter is set as WBR, and
the light-source-unit driving circuit drives the light source unit such that the light source unit in the common-color subframe period emits light with luminance obtained by multiplying emission luminance of the light source unit in each primary-color subframe period by the light emission control parameter WBR.

12. The image display device according to claim 11,
wherein the image data conversion unit obtains the distribution ratio and the adjustment coefficient in accordance with functions having a value which smoothly changes depending on the saturation.

13. The image display device according to claim 1,
wherein the image data conversion unit includes a parameter storage unit that stores a parameter used in the conversion processing, and
the parameter storage unit stores a parameter in accordance with response characteristics in image display in the display unit.

14. The image display device according to claim 13,
wherein the image data conversion unit further stores a parameter for designating a range of the maximum value in accordance with the minimum value of the pixel data values of each pixel in the input image in the plurality of subframe periods.

15. The image display device according to claim 1,
wherein the image data conversion unit includes a parameter storage unit that stores a parameter used in the conversion processing, and
the display unit includes a temperature sensor,
the parameter storage unit stores a plurality of values for the parameter, in accordance with a temperature, and
the image data conversion unit selects the value in accordance with the temperature measured by the temperature sensor among the plurality of values stored in the parameter storage unit and uses the selected value in the conversion processing.

16. The image display device according to claim 1,
wherein the image data conversion unit
includes a frame memory that stores the input image data, and
generates the driving image data corresponding to a pixel, based on the input image data which has been stored in the frame memory and corresponds to a plurality of pixels, for each pixel in the input image.

17. The image display device according to claim 1,
wherein the image data conversion unit performs the conversion processing on normalized luminance data.

18. The image display device according to claim 17,
wherein the image data conversion unit obtains the driving image data by performing response compensation processing on image data obtained after the conversion processing.

19. The image display device according to claim 1,
wherein the plurality of primary colors includes blue, green, and red, and
the common color is white.

20. A field sequential image display method in which a plurality of subframe periods including a plurality of primary-color subframe periods respectively corresponding to a plurality of primary colors and at least one common-color subframe period is included in each frame period, the method comprising:
an image-data conversion step of receiving input image data corresponding to the plurality of primary colors and generating driving image data corresponding to the plurality of subframe periods from the input image data by obtaining a pixel data value of each of the plurality of subframe periods for each pixel of an input image represented by the input image data, based on the input image data; and
a display step of displaying an image based on the driving image data,
wherein, in the image-data conversion step,
conversion processing of generating the driving image data from the input image data is performed such that a pixel data value of the achromatic pixel in the common-color subframe period is set to be greater than any of pixel data values in the plurality of primary-color subframe periods in a case where a hue and a saturation of each pixel of the input image in an HSV space are maintained, and the input image includes an achromatic pixel, and that a pixel data value of the pixel in the common-color subframe period is set to be greater than a minimum value and smaller than a maximum value of the pixel data values in the plurality of primary-color subframe periods in a case where the input image includes the pixel having the saturation greater than a predetermined value.
